(19) United States
(12) Patent Application Publication
(10) Pub. No.: US 2006/0284929 A1
(43) Pub. Date: Dec. 21, 2006

(54) Inkjet recording method and inkjet printer

(76) Inventors: Takahiro Matsuzawa, Tokyo (JP); Masakazu Date, Tokyo (JP); Shinichi Suzuki, Tokyo (JP); Hidenobu Ooya, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/544,264

(22) PCT Filed: Jan. 21, 2004
(86) PCT No.: PCT/JP04/00469

§ 371 Date: Aug. 2, 2005

(30) Foreign Application Priority Data
Feb. 4, 2003 (JP) 2003-027191

(51) Int. Cl. B41J 2/21

(52) U.S. Cl. 347/43

(57) ABSTRACT

An inkjet recording method having: jetting recording ink containing a color material onto a recording medium by a recording head, and colorless ink for improving gloss onto the recording medium by the recording head, to perform image formation; and determining an adhered amount of the colorless ink per unit area in response to an adhered amount of the recording ink per unit area.

### FIELD OF THE INVENTION

The present invention relates to an inkjet recording method and an inkjet printer, and particularly, to an inkjet recording method and an inkjet printer, which are for jetting ink for improving gloss onto a recording medium.

### BACKGROUND ART

An inkjet printer for performing image formation by jetting minute droplets of ink onto a recording surface of a recording medium has been rapidly widespread because higher image quality approaching that of a silver-halide photograph and price reduction of the apparatus have been realized therein thanks to a technological progress in recent years.

In the conventional inkjet printer, dye ink has been mainly used. The dye ink is soluble in a solvent, exhibits high-purity and clear color reproduction, and is free from granularity. Accordingly, the dye ink does not cause scattered light or reflected light, has high transparency and a clear hue. Therefore, the dye ink is excellent at printing a high-quality image. On the contrary, when molecules of the coloring matter are destroyed owing to a photochemical reaction and the like, a decrease of the number of molecules directly affects a colored density, and accordingly, there is a problem that the dye ink is poor in light resistance.

While on the other hand, other colorants advantageous in light resistance, ozone resistance and the like have been proposed. A representative example is pigment ink that has already been put into practical use, and further, the colorants include coloring particles formed by containing lipophilic dye such as dispersed dye in resin, wax ink (hot melt ink) formed by dispersing or dissolving a color material into wax, and the like.

Moreover, a recording medium in which gloss is extremely high, such as a swelling-type one mainly containing a water-soluble binder, is used as a recording medium. Alternatively, a mixed layer of thermoplastic fine particles and inorganic fine particles is provided on a surface layer of a micro-porous recording medium, and after an image is formed by using the pigment ink, a post treatment such as fixing with heat and pressure is performed for the image, and so on (for example, refer to European Patent Laid-Open Specification No. 1228891 as Patent Document). In such a way, high image gloss is adapted to be obtained.

However, in many cases, the pigment ink and the wax ink contain resin therein in order to improve dispersibility of the coloring particles, to improve rubfastness of the image, and to improve the image gloss. When the image formation is performed by using such ink, gloss of a highlighted portion in which image-unformed regions are more than image-formed regions and of a blank portion is lowered, and a feeling of wrongness occurs in the gloss as a whole. Specifically, it is strongly desired to eliminate the feeling of wrongness by solving unevenness of the gloss as a whole of the recording medium.

Moreover, in the case of using the swelling-type recording medium, ink absorption speed thereof is insufficient for a high-speed image forming printer in recent years, and accordingly, it is difficult to achieve compatibility between ink absorptivity and a solution of the low gloss inherent in the highlighted portion in which the image-unformed regions are many and in the blank portion.

Further, in the case of using the recording medium described in the above-described Patent Document, a certain amount of inorganic fine particles will be used in order to obtain sufficient ink absorptivity, and accordingly, the gloss of the highlighted portion and the blank portion is lowered than the image-formed regions.

It is an object of the present invention to suppress the unevenness of the gloss of the image-formed regions, the highlighted portion and the blank portion, thereby solving the feeling of wrongness.

### DISCLOSURE OF THE INVENTION

To solve the above problems, the inkjet recording method comprises:

jetting recording ink containing a color material onto a recording medium by a recording head, and colorless ink for improving gloss onto the recording medium by the recording head, to perform image formation; and

determining an adhered amount of the colorless ink per unit area in response to an adhered amount of the recording ink per unit area.

Moreover, the inkjet printer, comprises:

an image forming unit to jet recording ink containing a color material onto a recording medium by a recording head, and jet colorless ink for improving gloss onto the recording medium by the recording head, thereby performing image formation; and

a control unit to control the image forming unit, wherein the control unit determines an adhered amount of the colorless ink per unit area in response to an adhered amount of the recording ink per unit area.

According to the inkjet recording method and the inkjet printer of the present invention, the recording ink is jetted onto the recording medium, the colorless ink for improving the gloss is jetted onto the recording medium, and the image formation is thus performed. Accordingly, even if the gloss of the image-formed regions is improved by the color material contained in the recording ink, the colorless ink is jetted onto the blank portion and the highlighted portion in which the adhered amount of recording ink is small, thus making it possible to improve the gloss of these portions. In particular, the adhered amount of colorless ink per unit area is determined in response to the adhered amount of recording ink per unit area. Accordingly, the gloss on the recording surface of the recording medium can be made even, and the feeling of wrongness owing to the unevenness of the gloss can be solved.

Moreover, the colorless ink for use in the present invention stands for ink that does not substantially contain the color material, and it is preferable that a variation of ΔE of the image portion, which is caused by the existence of the colorless ink, be 3 or less. A gloss-imparting function to be referred to herein means a function to improve specular gloss (JIS-Z-8741) and image clarity (JIS-K-7105).

(Measurement of 60-Degree Gloss)

A 60-degree specular gloss of an image-formed surface was measured in accordance with JIS-Z-8741. For the measurement, a variable angle gloss system (VGS-1001DP) made by Nippon Denshoku Industries Co., Ltd. was used.

Moreover, in the inkjet recording method of the present invention, a jetted position of the colorless ink may be determined in response to a jetted position of the recording ink.

Meanwhile, in the inkjet printer of the present invention, the control unit may determine a jetted position of the colorless ink in response to a jetted position of the recording ink.

As described above, the jetted positions of the colorless ink are determined in response to the jetted positions of the recording ink, and accordingly, it is made possible to jet the colorless ink onto suitable positions with respect to the jetted positions of the recording ink.

Moreover, in the inkjet recording method of the present invention, the jetted position of the colorless ink may be determined preferentially from a position that is not adjacent to or overlapped on the jetted position of the recording ink.

Meanwhile, in the inkjet printer of the present invention, the control unit may determine the jetted position of the colorless ink preferentially from a position that is not adjacent to or overlapped on the jetted position of the recording ink.

As described above, the jetted positions of the colorless ink are determined preferentially from the positions which are not adjacent to or overlapped on the jetted positions of the recording ink, and accordingly, the colorless ink and the colorless ink can be prevented from being mixed with each other on the recording medium.

Moreover, in the inkjet recording method of the present invention, the adhered amount of colorless ink may be increased in a region where the adhered amount of recording ink is a predetermined amount or less than in a region where the adhered amount of recording ink is more than the predetermined amount.

Meanwhile, in the inkjet printer of the present invention, the control unit may increase the adhered amount of the colorless ink in a region where the adhered amount of the recording ink is a predetermined amount or less than in a region where the adhered amount of the recording ink is more than the predetermined amount.

As described above, on the region where the adhered amount of recording ink is equal to or less than the predetermined amount, the adhered amount of colorless ink is increased in comparison with that of the region where the adhered amount of recording ink is more than the predetermined amount. Accordingly, on the region where the adhered amount of recording ink is more than the predetermined amount, the adhered amount of colorless ink is reduced than that of the region where the adhered amount of recording ink is equal to or less than the predetermined amount. Then, ink of which amount exceeds a permissible ink absorption amount of the recording medium becomes less prone to be jetted. Hence, a liquid overflow which is caused because the recording medium cannot fully absorb the ink can be prevented.

Moreover, in the inkjet recording method of the present invention, the unit area for the adhered amounts of the colorless ink and the recording ink may be set at 1 mm square or less, and a sum total of the adhered amounts of the colorless ink and the recording ink in the unit area may be set at a predetermined amount or more.

Meanwhile, in the inkjet printer of the present invention, the control unit may set the unit area for the adhered amounts of the colorless ink and the recording ink at 1 mm square or less, and set a sum total of the adhered amounts of the colorless ink and the recording ink in the unit area at a predetermined amount or more.

In general, the adhered amount of ink in the inkjet recording method stands for an adhered amount thereof per fixed area of the recording medium, that is, an adhered amount thereof per unit area. The unit in this case is the overall surface area of the recording medium at the maximum, and is one pixel corresponding to a recording resolution at the minimum. In the case of improving evenness of characteristics of the recording medium, even if the adhered amount of colorless ink is controlled with the full recording surface taken as a unit, an effect brought therefrom is small, and this is obvious. Hence, a certain maximum value exists as a unit to be controlled in the case of jetting the colorless ink, and it is desirable to employ a value equal to or less than the maximum value concerned as the unit to be controlled.

As a result of a study of the inventor of the present invention, it has been found that, in the case of improving the evenness of the gloss of the recording surface, 2 mm or less is essential as the maximum unit to be controlled, and 0.5 mm square is more preferable. Resolving power of a human eye has the highest sensitivity at an interval of 0.5 mm when a distance of the eye to the recording medium is set at approximately 30 cm. Hence, in the case of ensuring evenness of a black density of the recording surface by means of dots of a recording head, it is necessary that the dots be distributed at a spatial frequency higher than the above.

Moreover, in the case of a printed matter with high image quality, a dot interval (so-called screen ruling) becomes 150 to 175, and a spatial frequency thereof has an interval of 0.169 to 0.145 mm.

However, it has been found that the resolving power of the human eye is not very high for characteristics such as the gloss, and that a very large feeling of wrongness does not occur even if portions with the gloss and portions without the gloss are distributed uniformly at an interval of approximately 1 mm. Specifically, according to the above-described inkjet recording method and inkjet printer, the unit area of the adhered amounts of colorless ink and recording ink is set at 1 mm square, and the sum total of the adhered amounts of colorless ink and recording ink within the unit area is set at the predetermined amount or more. Accordingly, the uniformity of the gloss on the recording surface can be enhanced more, and the feeling of wrongness owing to the unevenness of the gloss can be solved. Note that, though higher evenness can be obtained if a range finer than 1 mm square is employed as the unit area, it is obvious that it is the most efficient to make the control by means of a necessary and sufficient size unit in consideration of a calculation time required for the dot distribution.

Moreover, in the inkjet recording method of the present invention, the sum total of the adhered amounts of the colorless ink and the recording ink in the unit area may be 2 cc/m² or more.

Meanwhile, in the inkjet printer of the present invention, the control unit may set the sum total of the adhered amounts of the colorless ink and the recording ink in the unit area at 2 cc/m² or more.

As described above, the sum total of the adhered amounts of colorless ink and recording ink within the unit area is set at 2 cc/m² or more. Accordingly, the uniformity of the gloss on the recording surface can be enhanced more stably.

Moreover, in the inkjet recording method of the present invention, the sum total of the adhered amounts of the colorless ink and the recording ink in the unit area may be less than 13 cc/m².

Meanwhile, in the inkjet recording apparatus of the present invention, the control unit may set the sum total of the adhered amounts of the colorless ink and the recording ink in the unit area at less than 13 cc/m².

Here, when the sum total of the adhered amounts of the colorless ink and the recording ink within the unit area is set at 13 cc/m² or more, there is a possibility that the sum total exceeds the permissible ink absorption amount of the recording medium to cause the liquid overflow. Therefore, as in the above-described inkjet recording method and inkjet printer, if the sum total of the adhered amounts of the colorless ink and the recording ink within the unit area is set at less than 13 cc/m², the liquid overflow can be prevented.

Moreover, in the inkjet recording method of the present invention, the unit area for the adhered amounts of the colorless ink and the recording ink may be set as a block formed of an aggregate of n (n>1) pieces of pixels.

Meanwhile, in the inkjet printer of the present invention, the control unit may set the unit area for the adhered amounts of the colorless ink and the recording ink as a block formed of an aggregate of n (n>1) pieces of pixels.

In general, in the case of printing an image having gradation, such as a photograph, by an inkjet mode, the number of gradations for each pixel is short, and accordingly, a halftone process using error diffusion and a dither matrix becomes necessary. In this case, when the area of the unit to be controlled is set as a unit of the dither matrix, data for the colorless ink can be calculated simultaneously with the halftone process, and this is efficient. In particular, the dither matrix is a technique for use when a high-speed output is desired though the image quality is not required very much, where an effect that the calculation of the adhered amount of colorless ink can be made at the high speed is large. The dither matrix is one taking a×b (=n) pixels in a usual image as one block and using the block as a unit for determining dot formation, where a is the number of pixels in the lateral direction and b is the number of pixels in the longitudinal direction. Specifically, as in the above-described inkjet recording method and inkjet printer, if the unit area of the adhered amounts of the colorless ink and the recording ink is set as the block formed of an aggregate of the n (n>1) pieces of pixels, the adhered amounts of the recording ink and the colorless ink can be controlled correspondingly to the dither matrix.

Moreover, in the inkjet recording method of the present invention, a jetted position of the colorless ink jetted onto the block may be determined preferentially from a pixel in which the adhered amount of the recording ink is smaller.

Meanwhile, in the inkjet printer of the present invention, the control unit may determine a jetted position of the colorless ink jetted onto the block preferentially from a pixel in which the adhered amount of the recording ink is smaller.

As described above, the jetted position of the colorless ink jetted into the block is determined from the pixel in which the adhered amount of recording ink is smaller, and accordingly, the colorless ink can be jetted preferentially from a pixel on which the recording ink is not jetted, and this is effective from viewpoints of the ink overflow and the evenness of the gloss.

Moreover, in the inkjet recording method of the present invention, the unit area for the adhered amounts of the colorless ink and the recording ink may be defined as one pixel, and a sum total of the adhered amounts of the colorless ink and the recording ink in the unit area may be set at a predetermined amount or more.

Meanwhile, in the inkjet printer of the present invention, the control unit may define the unit area for the adhered amounts of the colorless ink and the recording ink as one pixel, and set a sum total of the adhered amounts of the colorless ink and the recording ink in the unit area at a predetermined amount or more.

As described above, the unit area of the adhered amounts of the colorless ink and the recording ink is set at one pixel, and the sum total of the adhered amounts of colorless ink and recording ink within the unit area is set at the predetermined amount or more. Accordingly, it is made possible to determine the adhered amount of colorless ink for each pixel.

Meanwhile, in the determination of the jetted position of the colorless ink, in the case of obtaining the jetted position concerned based on a jetted position of the recording ink after the halftone process, it is easy to determine the jetted position of the colorless ink based on the predetermined adhered amount by the block unit as described above. However, according to the above-described inkjet recording method and inkjet printer, it is made possible to calculate the adhered amount of colorless ink by using image data before the halftone process, and accordingly, the jetted position of the colorless ink can be calculated by performing the same process as the halftone process.

Moreover, in the inkjet recording method of the present invention, the recording ink may contain fine particles.

Meanwhile, in the inkjet printer of the present invention, the recording ink may contain fine particles.

The effect of improving the evenness of the gloss according to the present invention is effective in a combination of the recording medium and the ink, in which the recording ink is adhered onto the recording medium and the gloss is thus improved. The respective materials themselves are not limited at all. However, a particular effect is brought to a system using materials significantly exhibiting the above phenomenon. The materials as described above include those in the case of containing fine particles other than the color material in the recording ink itself, the case where the color material itself is fine particles, and a combination of these two cases, as in the above-describe inkjet recording method and inkjet printer.

Moreover, in the inkjet recording method of the present invention, the recording medium may include a micro-porous recording medium.

Meanwhile, in the inkjet printer of the present invention, the recording ink may contain fine particles.

As described above, the recording medium is the micro-porous recording medium, and accordingly, has higher ink absorption speed than the swelling-type recording medium, and can absorb the ink correspondingly to the image formation speed of the high-speed image forming printer. In such a way, it is made possible to make the gloss and the ink absorptivity compatible with each other.

Moreover, in the inkjet recording method of the present invention, a surface layer of the recording medium may contain a thermoplastic resin.

Meanwhile, in the inkjet printer of the present invention, the recording medium may include a micro-porous recording medium.

As described above, the surface of the recording medium contains the thermoplastic resin. Accordingly, an effect thereof is particularly high in the case of performing heating or fixing with pressure after the recording, further, in the case of using the above-described ink and medium in combination, and so on.

Moreover, in the inkjet recording method of the present invention, a fixing process including heating or pressurization may be implemented for the recording medium on which the recording ink and the colorless ink are jetted.

Meanwhile, in the inkjet printer of the present invention, a fixing process including heating or pressurization may be implemented for the recording medium on which the recording ink and the colorless ink are jetted.

When the surface layer of the recording medium contains the thermoplastic resin, if the recording ink and the colorless ink which are adhered onto the recording medium are melted or formed into a coating film, more excellent gloss can be obtained. Specifically, according to the above-described inkjet recording method and inkjet printer, the recording ink and the colorless ink are fixed onto the recording medium by a fixing process including the heating and the pressurization, and these inks can be thus melted or formed into the coating film, and the gloss can be further improved.

Moreover, in the inkjet recording method of the present invention, a rate of light absorbance change in mixing the recording ink and the colorless ink with each other may be less than 5%.

Meanwhile, in the inkjet printer of the present invention, a rate of light absorbance change in mixing the recording ink and the colorless ink with each other may be less than 5%.

If the rate of the light absorbance change in mixing the recording ink and the colorless ink with each other is 5% or more, for example, when the recording ink and the colorless ink are mixed with each other in a nozzle of the recording head, there is a possibility that the nozzle is clogged, bringing a lowering of the image quality and a lowering of the gloss as a result. Therefore, if the rate of the light absorbance change in mixing the recording ink and the colorless ink with each other is set at less than 5% in advance as in the above-described inkjet recording method and inkjet printer, the nozzle can be prevented from being clogged, and the lowering of the image quality and the lowering of the gloss can be prevented.

Moreover, the inkjet recording method of the present invention comprises:

jetting recording ink containing a color material onto a recording medium by a recording head, and a colorless ink for improving gloss onto the recording medium by the recording head, to perform image formation,

wherein a rate of light absorbance change in mixing the recording ink and the colorless ink with each other is less than 5%.

Meanwhile, the inkjet printer of the present invention comprises:

an image forming unit to jet recording ink containing a color material onto a recording medium by a recording head, and jet colorless ink for improving gloss onto the recording medium by the recording head, thereby performing image formation; and

a control unit to control the image forming unit,

wherein a rate of light absorbance change in mixing the recording ink and the colorless ink with each other is less than 5%.

As described above, the recording ink is jetted onto the recording medium, the colorless ink for improving the gloss is jetted onto the recording medium, and the image formation is thus performed. Accordingly, even if the gloss of the image-formed regions is improved by the color material contained in the recording ink, the colorless ink is jetted onto the blank portion and the highlighted portion in which the adhered amounts of recording ink are small, thus making it possible to improve the gloss of these portions. Moreover, the rate of the light absorbance change in mixing the recording ink and the colorless ink with each other is set at less than 5%, and accordingly, the nozzle can be prevented from being clogged, and the lowering of the image quality and the lowering of the gloss can be prevented.

### BRIEF DESCRIPTION OF THE DRAWINGS

FIG. 1 is a perspective view showing main constituents of an inkjet printer according to a first embodiment.

FIG. 2 is an enlarged perspective view of a carriage provided in the inkjet printer of FIG. 1.

FIG. 3 is a lower surface view of a recording head mounted on the carriage of FIG. 2.

FIG. 4 is a front view showing main constituents of a fixing unit provided in the inkjet printer of FIG. 1.

FIG. 5 is a block diagram showing a control circuit of the inkjet printer of FIG. 1.

FIG. 6 is a waveform diagram showing waveforms of voltages for driving the recording head of FIG. 3.

FIG. 7 is a block diagram showing main control unit of an image forming apparatus connected to the inkjet printer of FIG. 1.

FIG. 8 is a flowchart showing an outline of a process of a halftone module, which is performed in the image forming apparatus of FIG. 7.

FIGS. 9A and 9B are explanatory views for explaining jetted positions of colorless ink in the case of setting a block formed of 2×2 pixels as a unit area and the case of setting a block formed of 4×4 pixels as the unit area.

FIG. 10 is a flowchart showing an outline of a process of a halftone module, which is performed in an image forming apparatus of a second embodiment.

FIGS. 11A, 11B and 11C are specific examples of jetted positions of recording ink and the colorless ink in the case of setting a sum total of adhered amounts of recording ink and colorless ink at 25%.

FIGS. 12A and 12B are specific examples of the jetted positions of the recording ink and the colorless ink in the case of setting the sum total of the adhered amounts of colorless ink and recording ink at 25%.

FIGS. 13A and 13B are specific examples of the jetted positions of the recording ink and the colorless ink in the case of setting the sum total of the adhered amounts of colorless ink and recording ink at 25%.

FIGS. 14A, 14B and 14C are specific examples of jetted positions of the recording ink and the colorless ink in the case of setting the sum total of the adhered amounts of recording ink and colorless ink at 50%.

FIG. 15 is an explanatory view showing an assignment example of the recording ink for each gradation level in Example 1.

FIG. 16 is a graph in which an ink amount of a patch of each gradation level in Example 1 is plotted for each ink.

FIGS. 17A, 17B and 17C are explanatory views showing jetted positions of the colorless ink for each total sum amount when the sum total of the adhered amounts in Example 1 is changed.

FIG. 18 is a graph showing measurement values of gloss of 25 to 100% patches in Example 1.

FIG. 19 is a graph in which an ink amount of a patch of each gradation level in Example 2 is plotted.

FIG. 20 is a graph showing 60-degree gloss values when the colorless ink in Example 2 is changed from 25 to 100%.

FIGS. 21A and 21B are explanatory views for explaining jetted positions of the colorless ink in Example 3.

### BEST MODE FOR CARRYING OUT THE INVENTION

### First Embodiment

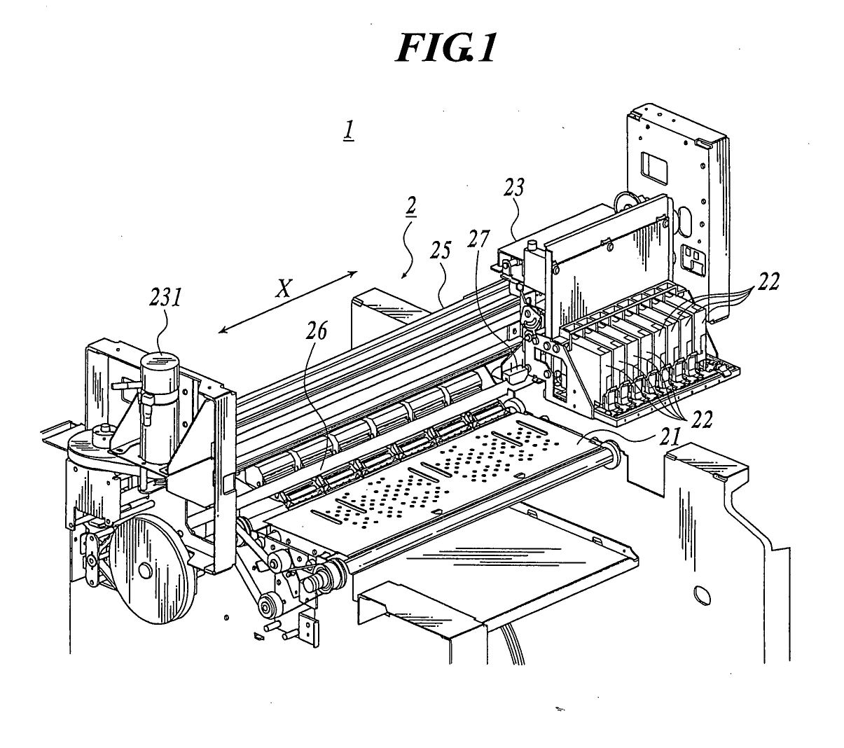

A first embodiment of the present invention will be described below with reference to FIG. 1 to FIG. 9.

In an inkjet recording method of the present invention, like a commercially available inkjet printer, one including a recording medium housing unit, a conveyor unit, an ink cartridge, and a recording head of an inkjet mode can be used without any limitation imposed thereon. However, if the inkjet printer is one of a series of printer sets each of which comprises at least a roll-like recording medium housing unit, the conveyor unit, the recording head of the inkjet mode, and a cutting unit, and according to need, a heating unit, a pressurization unit, and a recorded print housing unit, the inkjet printer is useful in the case of commercially utilizing an inkjet photograph.

First, the inkjet printer to which the inkjet recording method of the present invention can be applied will be described with reference to FIG. 1. FIG. 1 is a perspective view showing main constituents of the inkjet printer.

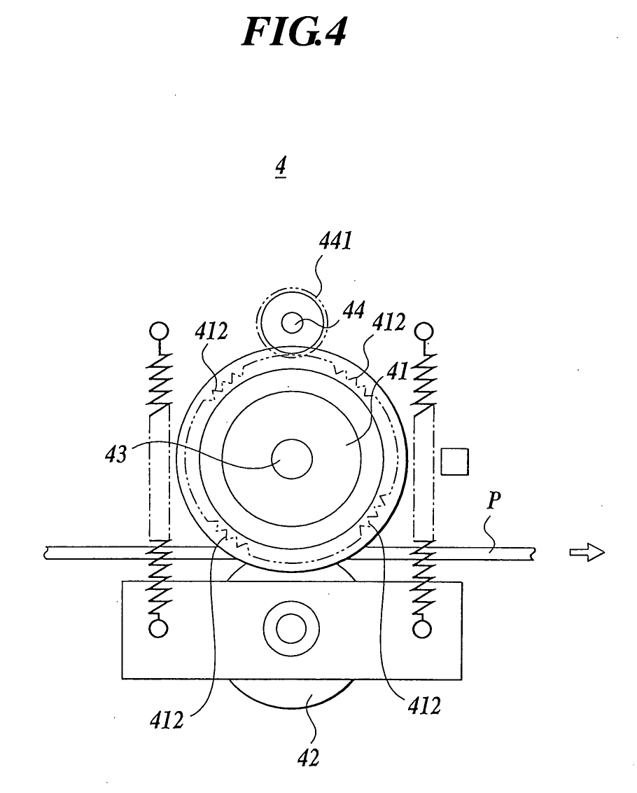

As shown in FIG. 1, in an inkjet printer 1, an image forming unit 2 for jetting ink onto a recording medium and forming an image thereon is provided. In the image forming unit 2, a platen 21 for supporting, on an upper surface thereof, a back surface (surface opposite to a recording surface) of a recording medium P (refer to FIG. 4) in a predetermined range is disposed substantially horizontally. Moreover, in the image forming unit 2, a guide member 25 extended along a scanning direction X above the platen 21 and for moving a carriage 23 scanning in the scanning direction X is provided.

On the carriage 23, mounted are recording heads 22 for jetting ink onto the recording medium, and a linear encoder sensor 27 extended along the scanning direction X and for reading optical patterns on a linear scale 26 in which the optical patters are arranged in a cycle of 180 dpi in a longitudinal direction thereof and for outputting the read optical patterns as a clock signal. A moving direction of the carriage 23 is changed in accordance with a rotation direction of a carriage drive motor 231, and the carriage 23 moves reciprocally in the scanning direction X. Moreover, at a time of image formation, the carriage 23 moves forward, backward or reciprocally in the scanning direction X while the recording medium P is being stopped. Moving speed at this time is, for example, 705 mm/s at the maximum.

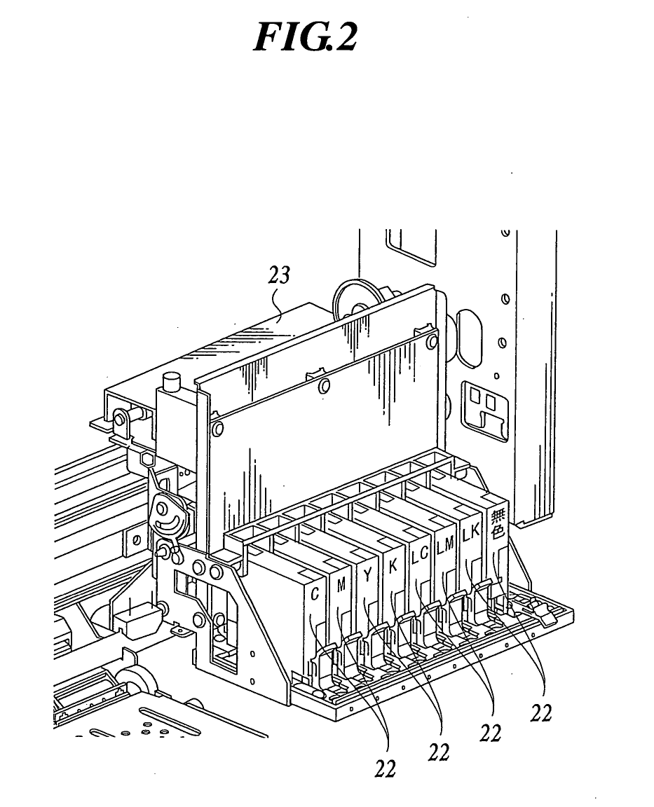

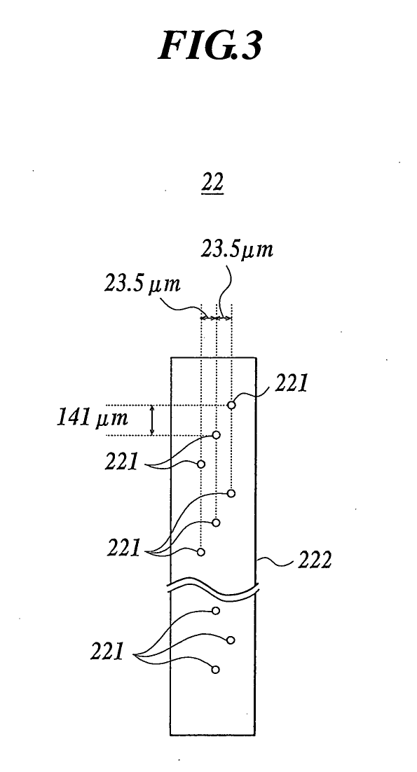

Next, each recording head 22 will be described with reference to FIG. 2 and FIG. 3. FIG. 2 is an enlarged perspective view of the carriage 24, and FIG. 3 is a lower surface view of the recording head 22.

The recording head 22 may be any one of a piezoelectric mode, a thermal mode and a continuous mode. However, the piezoelectric mode is preferable from a viewpoint of stability thereof in pigment ink, and in this embodiment, the recording head 22 of the piezoelectric mode is used. The recording head 22 is disposed so that the recording surface of the recording medium P conveyed on the platen 21 and a nozzle surface 222 on which nozzles 221 of the recording head 22 is formed can be opposed to each other.

As shown in FIG. 3, on the nozzle surface 222 of the recording head, nozzle arrays in which 255 pieces of nozzles 221 are formed in line of approximately three arrays at a pitch of 141 μm (180 dpi) in the conveying direction are arranged to be shifted from one another by 23.5 μm. This is equivalent to one pixel in 1080 dpi. This is for the purpose of, as a drive mechanism of the recording head 22, ensuring that the nozzle 221 drivable simultaneously is every three nozzles. Each recording head 22 has a jetting section (not shown) such as piezoelectric elements provided therein, and individually jets the ink as droplets from the respective nozzles 211 by an operation of the jetting section.

To each recording head 22, the ink is supplied from unillustrated recording ink cartridges and colorless ink cartridge through piping tubes. Eight recording heads 22 are arranged in line along the scanning direction, and are used for dark and light CMK, six in total, Y, and the colorless ink. In this embodiment, seven kinds of inks which are C, M, Y, K, LC, LM and LK are used as the recording inks. However, even in an inkjet printer for performing the recording by using only the dark C, M, Y and K without using the light colors, an effect of the present invention is similar.

Next, a fixing unit 4 for fixing the ink to the recording medium P on which the image is formed by the image forming unit 2 will be described with reference to FIG. 4. FIG. 4 is a front view showing main constituents of the fixing unit 4.

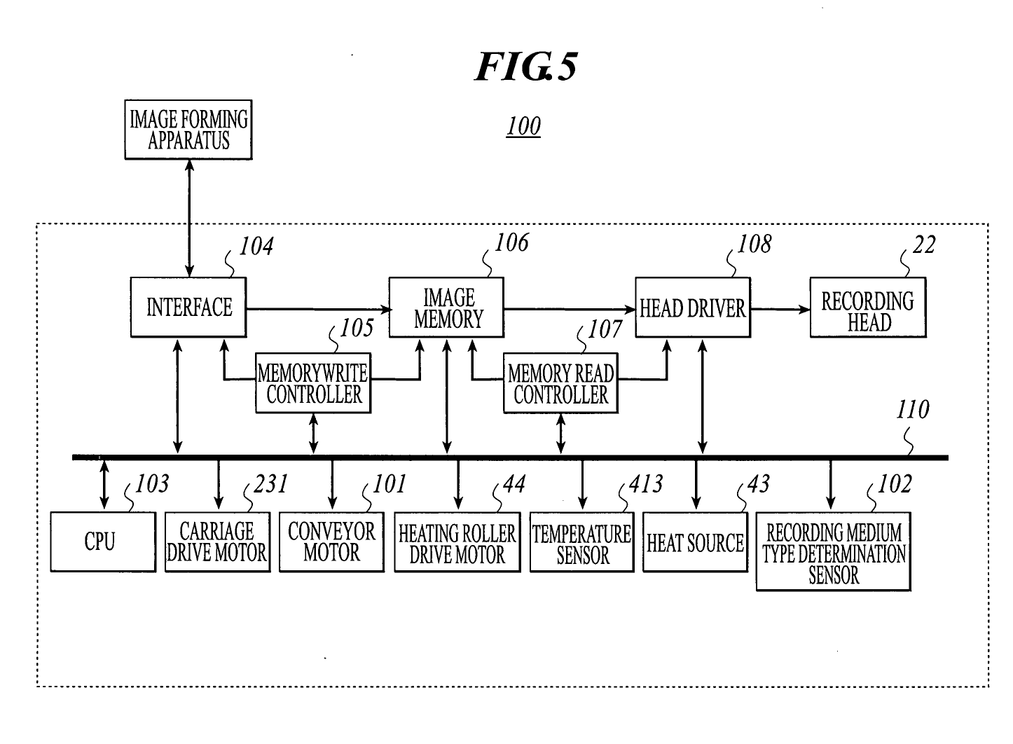

As shown in FIG. 4, the fixing unit 4 is disposed on a downstream side of the image forming unit 2 in the conveying direction of the recording medium P. In the fixing unit 4, there is provided a conveyor roller 42 extended in a direction perpendicular to the conveying direction of the recording medium P and for supporting and conveying the recording medium P from a lower side thereof. To an upper side of the conveyor roller 42, a heating roller 41 formed of a hollow roller faces. In the inside of the heating roller 41, a heat source 43 such as a halogen lump heater, a ceramic heater and a Nichrome wire is provided. The heating roller 41 is heated by heat of the heat source 43, thermoplastic resin particles contained in an ink receiving layer of the recording medium P are melted. A temperature sensor 413 (refer to FIG. 5) is built in the heating roller 41. Moreover, a gear 412 is formed on a peripheral edge of an end of the heating roller 41, and meshes with a gear 441 attached onto a heating roller drive motor 44. By these gear 441 and gear 441, drive force of the heating roller drive motor 44 is adapted to be transmitted to the heating roller 41, and to rotationally drive the heating roller 41 in a predetermined direction. It is preferable that the heating roller 41 be formed of a material high in thermal conductivity so as to make it possible to heat the recording medium P efficiently by the heat radiated from the heat source 43. For example, a metal roller is mentioned. It is preferable that, on the surface of the heating roller 41, fluorine resin be coated in order to prevent contamination owing to the ink at the time of heating and pressurizing the recording medium P. Besides, a silicon rubber roller coated with heat-resistant silicon rubber can also be used.

Next, a control circuit of the inkjet printer 1 will be described with reference to FIG. 5. FIG. 5 is a block diagram showing the control circuit of the inkjet printer 1.

As shown in FIG. 5, a control circuit 100 is configured in such a manner that a conveyor motor 101 for conveying the recording medium P, a recording medium type determination sensor 102 for determining a type of the recording medium P, a CPU 103, an interface 104, the carriage drive motor 231, the heating roller drive motor 44, the temperature sensor 413, the heat source 43, a memory write controller 105, an image memory 106, a memory read controller 107, a head driver 108, and the recording head 22, are connected to one another through a bus 110. Note that, besides these, the respective drive units of the inkjet printer 1, and the like are connected to the control circuit 100.

The control circuit 100 controls conveyance of the recording medium P, a scanning operation of the carriage 23, the ink jetting of the recording head 22, and the like.

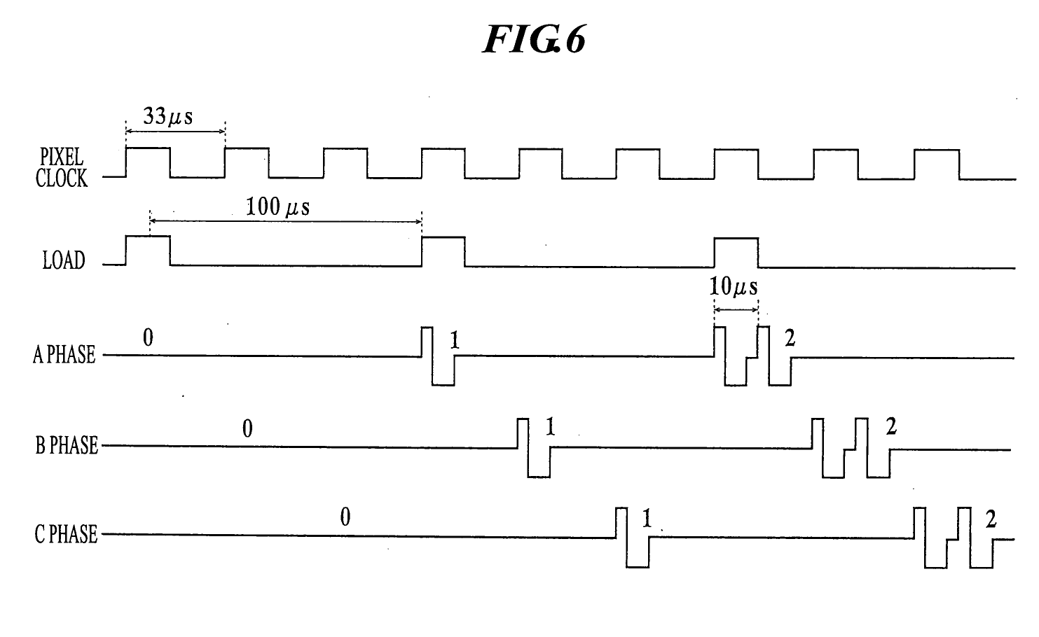

When the control unit 100 controls the recording head 22, as shown in FIG. 6, data of 255 pixels in each array of the respective recording heads 22 is read for a time of three cycles of a pixel clock as a cycle of 33 μs, that is, for 100 μs, and is transferred to the head driver 108. The head driver 108 generates a head drive pulse signal responding to the data of three values corresponding to each nozzle 221 at timing corresponding to a phase of each nozzle 221. Specifically, the head driver 108 does not generate the pulse signal when the data is “0”, generates one pulse when the data is “1”, and generates two pulses at an interval of approximately 10 μs when the data is “2”. Moreover, head drive pulses in the respective phases A, B and C are generated at timing shifted by 33 μs for one pixel clock.

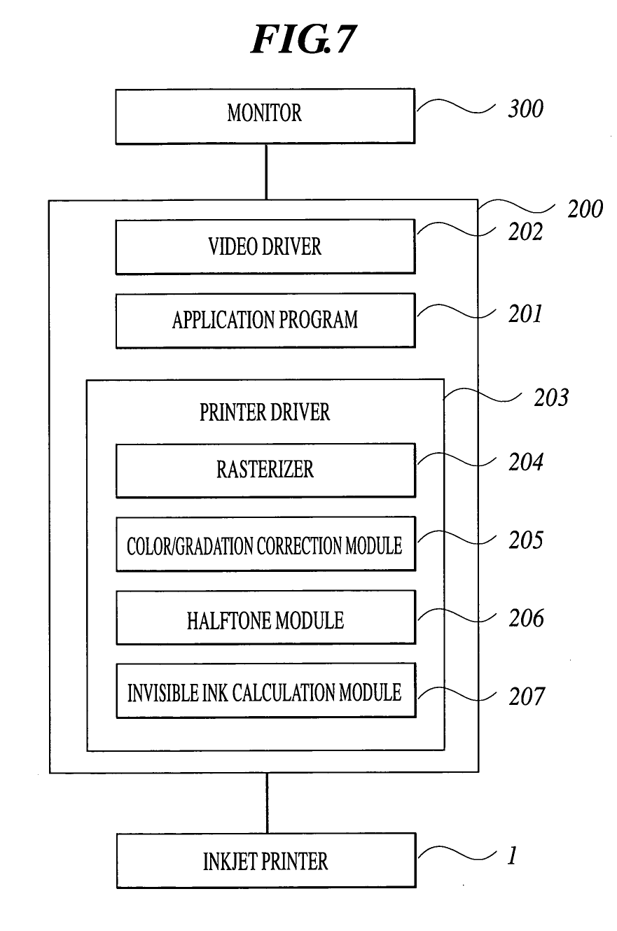

Moreover, as shown in FIG. 5 and FIG. 7, an image forming apparatus 200 such as a computer is connected to the control circuit 100. The image forming apparatus 200 forms a multicolor image based on a signal inputted thereto. In this example, an application program 201 operating in the inside of the image forming apparatus 200 displays the image on a monitor 300 through a video driver 202 while performing a process for the image. When the application program 201 issues an instruction to form the image, a printer driver 203 of the image forming apparatus 200 receives image data for forming the image from the application program 201, and converts the image data into a signal by which the image is formable in the inkjet printer 1. Specifically, in this embodiment, the control circuit 100 and the image forming apparatus 200 will serve as a control unit of the present invention.

The printer driver 203 includes a rasterizer 204 for converting the image data handled by the application program 201 into color information per dot unit, a color gradation correction module 205 for correcting the image gradation data converted into the color information per dot unit in accordance with color reproduction property and gradation property of the inkjet printer 1, a halftone module 206 for generating-so-called halftone image data expressing a density on a certain area, that is, data for the recording ink, which expresses the jetted position, the adhered amount and the like of the recording ink, by the presence or absence of the recording ink per dot unit from the image data having been subjected to color correction, and a colorless ink calculation module 207 for generating data for the colorless ink, which represents the jetted position and adhered amount of the colorless ink based on the data for the recording ink, which is generated in the halftone module 206.

Next, the recording medium for use in this embodiment will be described.

Mediums in general for use in usual inkjet recording are applicable as the recording medium; however, a type having an ink absorbing layer on a support is preferable from a viewpoint of the image quality, and the type includes a swelling type and a micro-porous type.

As the one of the swelling type, usable is one formed by applying, for example, gelatin, polyvinyl alcohol, polyvinyl pyrrolidone, polyethylene oxide and the like alone or in combination as a hydrophilic binder, and by making the hydrophilic binder as the ink absorbing layer.

In the recording medium having the micro-porous ink absorbing layer, the gloss is significantly improved by the recording ink, and accordingly, the recording medium serves as a preferred embodiment of the present invention. The ink absorbing layer of the micro-porous recording medium may be configured to have either a single layer, or two or more layers. In particular, it is preferable to use an inkjet recording medium having an ink absorbing layer of a double-layer configuration, in which a first ink absorbing layer containing inorganic pigment is provided on a support, and thereon, a second ink absorbing layer containing thermoplastic resin to be described later and inorganic pigment are provided. The micro-porous ink absorbing layer will be descried below more in detail.

(Micro-Porous Ink Absorbing Layer)

A micro-porous layer is one mainly formed by soft aggregation of the hydrophilic binder and the inorganic pigment. Heretofore, various methods for forming micropores in a coating film have been known, for example, which are: a method of applying a uniform coating solution containing two or more polymers onto a support, and allowing these polymers to cause phase separation in a drying process, thereby forming micropores; a method of applying a coating solution containing solid fine particles and a hydrophilic or hydrophobic binder onto a support, and after drying, immersing an inkjet recording medium in water or a liquid containing an appropriate organic solvent to dissolve the solid fine particles, thereby forming the micropores; a method of applying a coating solution containing a compound having property to foam at the time of forming the coating film, and thereafter, foaming the compound in a drying process, thereby forming the micropores in the coating film; a method of applying a coating solution containing porous solid fine particles and a hydrophilic binder onto a support, thereby forming the micropores in the porous solid fine particles and between the fine particles; a method of applying, onto a support, a coating solution containing solid fine particles and/or fine particle oil droplets having a volume nearly equal to or more than that of a hydrophilic binder and the hydrophilic binder, thereby forming the micropores between the solid fine particles; and the like. In the present invention, it is particularly preferable that the micropores be formed by allowing the micro-porous layer to contain various inorganic solid fine particles with a mean particle diameter of 100 nm or less.

As the inorganic pigment for use under the above-described object, for example, white inorganic pigment and the like are mentioned, such as soft calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminium silicate, diatomite, calcium silicate, magnesium silicate, synthetic amorphous silica, colloidal silica, alumina, colloidal alumina, pseudoboehmite, aluminium hydroxide, lithopone, zeolite and magnesium hydroxide.

The mean particle diameter of the inorganic pigment is obtained as a simple mean value (number mean) by observing the particles or particles appearing on a cross section or a surface of the micro-porous layer by means of an electron microscope and by randomly measuring particle diameters of 1,000 particles. Here, the particle diameter of each particle is one represented by a diameter when a circle equal to a projection area thereof is assumed. As the solid fine particles, it is preferable to use solid fine particles of a substance selected from silica, alumina and alumina hydrate, and more preferable to use solid fine particles of silica.

As the silica, preferably used is silica synthesized by a usual wet method, colloidal silica, silica synthesized by a vapor phase method, or the like. Fine particle silica preferably used in particular in the present invention is the colloidal silica or fine particle silica synthesized by the vapor phase method. Among them, the fine particle silica synthesized by the vapor phase method is preferable because not only the fine particle silica can obtain a high void rate but also is less prone to form a rough and large aggregation when being added to a cationic polymer for the purpose of immobilizing dye. Moreover, alumina or alumina hydrate may be either crystalline or amorphous, and it is possible to use those with any shape, such as undefined shaped particles, spherical particles and needle particles.

With regard to the fine particles, it is preferable that a fine particle dispersion thereof before being mixed with the cationic polymer be in a state of being dispersed into primary particles.

It is preferable that a particle diameter of the inorganic pigment be 100 nm or less. For example, in the case of the above-descried fine particle silica by the vapor phase method, a mean particle diameter (particle diameter in a dispersion state before application thereof) of the primary particles of the inorganic pigment dispersed in a state of the primary particles concerned is, preferably 100 nm or less, more preferably 4 to 50 nm, most preferably 4 to 20 nm.

As the most preferably used silica synthesized by the vapor phase method, in which the mean particle diameter of the primary particles is 4 to 20 nm, for example, Aerosil of Nippon Aerosil Co., Ltd. is commercially available. Such fine particle silica by the vapor phase method can be dispersed into the primary particles relatively easily, for example, by being sucked and dispersed by a jet stream inductor mixer made by Mitamura Riken Kogyo Inc.

The hydrophilic binder includes, for example, polyvinyl alcohol, gelatin, polyethylene oxide, polyvinyl pyrrolidone, polyacrylic acid, polyacrylamide, polyurethane, dextran, dextrin, carrageenan (κ, l, λ, etc.), agar, pullulan, water-soluble polyvinyl butyral, hydroxyethylcellulose, carboxymethylcellulose, and the like. It is possible to combine two or more of these water-soluble resins.

The water-soluble resin preferably used in the present invention is polyvinyl alcohol. In the polyvinyl alcohol preferably used in the present invention, modified polyvinyl alcohols such as polyvinyl alcohol where a terminal thereof is modified with cation and anion modified polyvinyl alcohol having an anionic group are included besides usual polyvinyl alcohol obtained by hydrolyzing polyvinyl acetate.

As polyvinyl alcohol obtained by hydrolyzing vinyl acetate, those with an average polymerization degree of 1,000 or more are preferably used, and particularly those with an average polymerization degree of 1,500 to 5,000 are preferably used. A saponification degree is preferably from 70 to 100%, and particularly preferably 80 to 99.5%.

The cation modified polyvinyl alcohol is, for example, the polyvinyl alcohol having primary to tertiary amino groups and quaternary ammonium groups in a backbone or side chains as described in JP-Tokukaisho-61-10483A, and this is obtained by saponifying a copolymer of an ethylenic unsaturated monomer having cationic group and vinyl acetate.

As the ethylenic unsaturated monomer having cationic group, for example, trimethyl-(2-acrylamide-2,2-dimethylethyl)ammonium chloride, trimethyl-(3-acrylamide-3,3-dimethylpropyl)ammonium chloride, N-vinylimidazole, N-vinyl-2-methylimidazole, N-(3-dimethylaminopropyl)methacrylamide, hydroxylethyltrimethylammonium chloride, trimethyl-(2-methacrylamidepropyl)ammonium chloride, N-(1,1-dimethyl-3-dimethylaminopropyl)acrylamide, and the like, are included.

A percent of cation modified group-containing monomer of the cation modified polyvinyl alcohol is from 0.1 to 10 mol %, and preferably from 0.2 to 5 mol % based on vinyl acetate.

As anion modified polyvinyl alcohol, for example, polyvinyl alcohol having an anionic group as described in JP-Tokukaihei-1-206088A, copolymers of vinyl alcohol and a vinyl compound having a water-soluble group as described in JP-Tokukaisho-61-237681A and JP-Tokukaisho-63-3079799A, and modified polyvinyl alcohol having a water-soluble group as described in JP-Tokukaihei-7-285265A are included.

As nonionic modified polyvinyl alcohol, for example, polyvinyl alcohol derivatives where a polyalkyleneoxide group is added to a part of vinyl alcohol as described in JP-Tokukaihei-7-9758A, a block copolymer of a vinyl compound having a hydrophobic group and vinyl alcohol as described in JP-Tokukaihei-8-25795A, and the like are included.

Polyvinyl alcohol can be also used in combination with two or more depending on difference in polymerization degree and modification type.

An added amount of the inorganic pigment for use in the ink absorbing layer largely depends on a required ink absorbing capacity, a void rate of the micro-porous layer, a type of the inorganic pigment and a type of the water-soluble resin; however, the added amount is 5 to 30 g in usual, and preferably 10 to 25 g per m² of a recording sheet.

Moreover, a ratio of the inorganic pigment and the water-soluble resin which are for use in the ink absorbing layer is 2:1 to 20:1 in usual, and preferably 3:1 to 10:1 in a mass ratio.

The ink absorbing layer may also contain a cationic water-soluble polymer having quaternary ammonium bases in molecules, and the cationic water-soluble polymer is used in a range of 0.1 to 10 g in usual, and preferably 0.2 to 5 g per m² of the inkjet recording medium.

In the micro-porous layer, it is preferable that a total amount (void capacity) of the micropores be 20 ml or more per m² of the recording sheet. In the case where the void capacity is less than 20 ml/m², though ink absorptivity is good when an ink amount at the time of printing is small, the ink is not completely absorbed when the ink amount is increased, making it prone to cause such problems as lowering of the image quality and a delay in drying property.

In the micro-porous layer having a function to retain the ink, the void capacity with respect to a solid capacity is referred to as a void rate. In the present invention, it is preferable to set the void rate at 50% or more because it is possible to form the micropores efficiently without unnecessarily thickening a film thickness of the micro-porous layer.

With regard to other types of the micro-porous ink absorbing layer, such an ink solvent absorbing layer may be formed by using a coating solution prepared by combining a polyurethane resin emulsion and a water-soluble epoxy compound and/or acetoacetylated polyvinyl alcohol with each other, and further, combining epichlorohydrin polyamide resin therewith, besides forming the ink solvent absorbing layer by using the inorganic pigment. As the polyurethane resin emulsion in this case, preferable is a polyurethane resin emulsion in which a diameter of particles having polycarbonate chains, polycarbonate chains and polyester chains is 3.0 μm. It is more preferable that polyurethane resin of the polyurethane resin emulsion obtained by reacting an aliphatic isocyanate compound and polyol having polycarbonate polyol, polycarbonate polyol and polyester polyol with each other have sulfonic acid groups in molecules, and further, have epichlorohydrin polyamide resin and a water-soluble epoxy compound and/or acetoacetylated vinyl alcohol.

It is assumed that, in the ink solvent absorbing layer using the above-described polyurethane resin, a weak aggregation of the cation and the anion is formed, followed by forming of micropores having power to absorb the ink solvent, thereby enabling the image formation.

(Thermoplastic Resin-Containing Layer)

In the present invention, a layer containing the thermoplastic resin can be provided on the surface layer of the ink absorbing layer. The layer containing the thermoplastic resin may be either a layer formed only of the thermoplastic resin or one added with a water-soluble binder according to needs. However, one is preferable, to which both of the water-soluble binder and the inorganic pigment are added. As the inorganic pigment addable to the thermoplastic resin, usable is the matter previously described in the explanation of the ink absorbing layer.

It is preferable that the thermoplastic resin be formed into a fine particle shape from a viewpoint of ink permeability. The thermoplastic resin or the fine particles thereof include, for example, polycarbonate, polyacrylonitrile, polystyrene, polyacrylic acid, polymethacrylic acid, an acrylic ester copolymer, polyvinyl chloride, polyvinylidene chloride, polyvinyl acetate, polyester, polyamide, polyether, copolymers thereof, and salts thereof. Among them, preferable are a styrene-acrylic acid ester copolymer, a methacrylic acid ester-acrylic acid ester copolymer, a vinyl chloride-vinyl acetate copolymer, an acrylic ester copolymer, a vinyl chloride-acrylic acid ester copolymer, an ethylene-vinyl acetate copolymer, an ethylene-acrylic acid ester copolymer, and SBR latex. More preferable thermoplastic resin is the acrylic ester copolymer.

For the thermoplastic resin or the fine particles thereof, plural polymers different in monomer composition, particle diameter and polymerization degree may be mixed together for use.

When selecting the thermoplastic resin or the fine particles thereof, ink receiving property, the gloss of the image after the fixing by the heating and the pressurization, image robustness and mold release property should be considered.

With regard to the ink receiving property, when the particle diameter of the thermoplastic fine particles is less than 0.05 μm, separation of pigment particles in the pigment ink and the ink solvent becomes slow, bringing lowering of the ink absorption speed. Meanwhile, when the particle diameter exceeds 10 μm, this is not preferable from viewpoints of adhesiveness of the thermoplastic resin to a solvent absorbing layer adjacent to the ink absorbing layer when the thermoplastic resin is applied onto the support, coating film strength of the inkjet recording medium after the application and drying thereof, development of the gloss, and the like. Therefore, the particle diameter of the thermoplastic resin is preferably 0.05 to 10 μm, more preferably 0.1 to 5 μm, and far more preferably 0.1 to 1 μm.

Moreover, a criterion for selecting the thermoplastic resin or the fine particles thereof includes a glass transition point (Tg). When Tg is lower than application and drying temperature, for example, the application and drying temperature at the time of preparing the recording medium is already higher than Tg, the micropores by the thermoplastic fine particles for transmitting the ink solvent therethrough will disappear.

Moreover, when Tg is equal to or more than temperature at which denaturation owing to the heat of the support occurs, a fixing operation at high temperature becomes necessary because the pigment ink is melted and deposited after the inkjet recording thereby, and a load on the apparatus, thermal stability of the support, and the like will become problems. Preferable Tg of the thermoplastic fine particles is 50 to 150° C. Moreover, 50 to 150° C. is preferable as the minimum film forming temperature (MFT).

From a viewpoint of environmental adaptability, as the fine particles of the thermoplastic resin, one dispersed in an aqueous system is preferable, and in particular, aqueous latex obtained by emulsion polymerization is preferable. In this case, a type subjected to the emulsion polymerization by using a nonionic dispersant as an emulsifier is preferably usable. Moreover, it is preferable that the fine particles of the thermoplastic resin have a less remaining monomer component from viewpoints of an odor and safety, and the remaining monomer component with respect to a solid mass of the polymer is preferably 3% or less, more preferably 1% or less, and particularly preferably 0.1% or less. Moreover, it is preferable that a remaining polymerization initiator be a little. While it is preferable that a ratio of the remaining polymerization initiator be 0.5% or less with respect to the solid mass of the polymer, it is the most preferable that the polymerization initiator should not remain at all.

As the water-soluble binder, polyvinyl alcohol and polyvinyl pyrrolidone are usable within a range of 1 to 10% of the fine particles of the thermoplastic resin.

It is preferable that the recording medium include the ink absorbing layer on the support, and that the surface layer thereof contain at least the inorganic pigment and the fine particles of the thermoplastic resin. In particular, the following points can be mentioned as reasons that it is preferable as above.

1) The ink absorption speed is large, image deterioration such as beading and color bleed is less prone to occur, and adaptability to high-speed printing is inherent.

2) Strength of the image surface is strong.

3) Sticking when the images are stacked on one another at the time of storage is less prone to occur.

4) Application productivity of the ink absorbing layer is excellent.

5) Writability is provided.

In this case, it is preferable to determine solid mass ratios of the fine particles of the thermoplastic resin and the inorganic pigment on the surface layer individually in accordance with the fine particles of the thermoplastic resin, the inorganic pigment, other additives and the like, and no particular limitations are imposed thereon. However, the ratio of the fine particles of the thermoplastic resin and the inorganic pigment is preferably 2/8 to 8/2, more preferably, 3/7 to 7/3, and far more preferably 4/6 to 6/4.

(Support)

As the support, usable is a support used heretofore for the inkjet recording medium, for example, a paper support such as regular paper, art paper, coated paper and cast-coated paper, a plastic support, a paper support having both surfaces coated with polyolefin, and a complex support formed by pasting these together.

For the purpose of increasing adhesion strength of the support and the ink receiving layer, it is preferable to give a corona discharge treatment, an undercoating treatment and the like to the support prior to the application of the ink receiving layer. Moreover, it is not always necessary that the recording medium be invisible, and the recording medium may also be colored. Moreover, it is particularly preferable to use a paper support in which both surfaces of an original support are laminated with polyethylene because a recorded image approaches photograph image quality and a high-quality image can be obtained at low cost.

The paper support as described above, which is laminated with polyethylene, will be described below. Original paper for use in the paper support is formed of wood pulp as a main material, and according to needs, synthetic pulp such as polypropylene or synthetic fiber such as nylon and polyester is used in addition to the wood pulp, and the original paper is thus formed into paper. As the wood pulp, for example, any of LBKP, LBSP, NBKP, NBSP, LDP, NDP, LUKP and NUKP can be used. However, it is preferable to use more LBKP, NBSP, LBSP, NDP and LDP each containing many short fibers. Note that a ratio of the LBSP or the LDP is preferably 10 to 70 mass %.

For the above-described pulp, chemical pulp (sulfate pulp and sulfite pulp) with little impurities is preferably used, and moreover, pulp in which a whiteness degree is improved by undergoing a bleaching treatment is also useful.

Into the original paper, for example, a sizing agent such as higher fatty acid and alkylketene dimer, white pigment such as calcium carbonate, talc and titanium oxide, a paper power enhancer such as starch, polyacrylamide and polyvinyl alcohol, a fluorescent brightening agent, a moisture retaining agent such as polyethylene glycols, a dispersant, a softening agent such as quaternary ammonium, and the like, can be added as appropriate.

A freeness of the pulp for use in making the paper is preferably 200 to 500 ml in the definition of the CSF, and the sum of a mass percent of 24 mesh residue and a mass percent of 42 mesh residue, in which fiber length after being beaten is defined in JIS-P-8207, is preferably 30 to 70%. Note that it is preferable that a mass percent of 4 mesh residue be 20 mass % or less.

Basis weight of the original paper is preferably 30 to 250 g, particularly preferably 50 to 200 g. Thickness of the original paper is preferably 40 to 250 μm.

The original paper undergoes a calendering treatment at a paper-making step or after the paper making, thus also making it possible to impart high smoothness thereto. In general, a density of the original paper is 0.7 to 1.2 g/m² (JIS-P-8118). Moreover, a stiffness of the original paper is preferably 20 to 200 g under the condition defined in JIS-P-8143.

A surface sizing agent may be applied onto the surface of the original paper. As the surface sizing agent, the sizing agent such as higher fatty acid and alkylketene dimer, which is addable into the above-described original paper, is usable.

pH of the original paper is preferably 5 to 9 when being measured by a hot water extraction method defined in JIS-P-8113.

Polyethylene that coats the surface and back surface of the original paper is mainly low-density polyethylene (LDPE) and/or high-density polyethylene (HDPE); however, LLDPE, polypropylene and the like other than the above are also usable partially.

In particular, for the polyethylene layer on the ink absorbing layer side, one is preferable, in which, like being widely performed in photographic printing paper, rutile or anatase-type titanium oxide is added into the polyethylene, thereby improving opacity and the whiteness degree. A content of the titanium oxide is 3 to 20 mass % in usual, and preferably 4 to 13 mass % with respect to the polyethylene.

The polyethylene-coated paper is usable as glossy paper. Moreover, one on which a matte surface as obtained in a usual photographic printing paper is formed by performing a so-called embossing process when the polyethylene is melted and extruded onto the surface of the original paper and coated thereon is also usable in the present invention.

A usage amount of the polyethylene on the front and back of the original paper is selected so as to optimize curls under low humidity and high humidity after the micro-porous layer and a backing layer are provided. However, in usual, in terms of thickness, a polyethylene layer on the micro-porous layer side is within a range of 20 to 40 μm, and a polyethylene layer on the backing layer side is within 10 to 30 μm.

[Preparation of Recording Medium]

A preparation method of the recording medium for use in this embodiment will be described by taking a specific example.

On the paper support (having thickness of 220 μm and containing 13 mass % of the anatase-type titanium oxide with respect to the polyethylene of the ink absorbing layer surface in the polyethylene) in which both surfaces were coated with the polyethylene, an underlayer coating solution to be described later was applied as a first layer from the support side, and a surface layer coating solution to be described later was simultaneously applied thereon as a second layer by a slide hopper, followed by drying, thereby preparing the recording medium 1.

Note that the coating solution was applied while being heated up to 40° C., and immediately after the application, the recording medium 1 was cooled down for 20 seconds in a cooling zone maintained at 0° C. Thereafter, the recording medium 1 was sequentially dried for 60 seconds in a wind (relative humidity: 15%) of 25° C., for 60 seconds in a wind (relative humidity: 25%) of 45° C., and for 60 seconds in a wind (relative humidity: 25%) of 50° C., and was conditioned in humidity for 2 minutes under the atmosphere where the relative humidity is 40 to 60° C. Then, a sample was taken up. Note that the application was performed so that an attached amount of silica could be 18 g/m² in the underlayer, and that an attached amount of silica could be 3 g/m² in the surface layer.

To the above-described coating solution, UVITE NFW LIQUID (prepared by Ciba Specialty Chemicals Inc.) as a water-soluble fluorescent brightening agent was added to reach an amount of 100 mg/m². Moreover, to the above-described coating solution, the same fluorescent brightening agent was added to reach an amount of 20 mg/m².

(Preparation of Silica Dispersion)

125 kg of vapor phase method silica (QS-20: prepared by Tokuyama Corp.) in which a mean particle diameter of primary particles was approximately 0.012 μm was sucked and dispersed at room temperature in 620 L of pure water of which pH was adjusted at 2.5 by nitric acid by using the jet stream inductor mixer TDS made by Mitamura Riken Kogyo Inc. Subsequently, a silica dispersion was finished into a total amount of 694 L by pure water.

Next, to 18 L of a solution (ph=2.3) containing 1.14 kg of cationic polymer P-1, 2.2 L of ethanol and 1.5 L of n-propanol, 69.4 L of the above-described silica dispersion was added while being agitated. Subsequently, 7.0 L of an aqueous solution containing 260 g of boric acid and 230 g of borax was added, and 1 g of an antifoaming agent SN381 (prepared by San Nopco Limited) was added. This mixed solution was dispersed by a high-pressure homogenizer made by Sanwa Industries Co., Ltd., and was finished into a total amount of 97 L by pure water, thereby preparing the silica dispersion.

(Preparation of Underlayer Coating Solution)

While 600 ml of the above-described silica dispersion was being agitated at 40° C., the respective additives to be described below were sequentially mixed therewith, thereby preparing the underlayer coating solution.

| | |
|---|---|
| 10% aqueous solution of polyvinyl alcohol | 6 ml |
| (PVA203: prepared by Kuraray Co., Ltd.) | |
| 7% aqueous solution of polyvinyl alcohol | 185 ml |
| (PVA235: prepared by Kuraray Co., Ltd.) | |
| Saponin (50% aqueous solution) | appropriate |
| | amount |
| Pure water | equivalent to finish the total |
| | amount to 1000 ml |

(Preparation of Surface Layer Coating Solution)

After being prepared, the above-described underlayer coating solution was agitated at 43° C. for 30 minutes, and subsequently, thermoplastic fine particles (acrylic latex, 82° C. of Tg, 160 nm of number mean particle diameter, 25% of solid content) were added thereto during 15 minutes so that a solid content ratio of the thermoplastic fine particles/filler (silica) could be 55/45, thereby preparing the surface layer coating solution 1. After being filtered by a filter of 10 μm the surface layer coating solution 1 was used for the application.

Next, the recording ink and the colorless ink for use in the inkjet printer 1 of this embodiment will be described.

[Recording Ink]

The color material of the recording ink may be either the dye or the pigment as long as the recording ink has adaptability to the inkjet mode in general. Particularly, in the case of making much of the viewpoints of the image permanence and the image quality, the pigment ink is preferable.

(Pigment)

As the pigment, organic pigment such as insoluble pigment and lake pigment and carbon black are preferably usable. No particular limitations are imposed on the insoluble pigment. However, for example, azo, azomethine, methane, diphenylmethane, triphenylmethane, quinacridone, anthraquinone, perylene, indigo, quinophthalone, isoindolinone, isoindoline, azine, oxazine, thiazine, dioxazine, thiazole, phthalocyanine, diketopyrrolopyrrole, and the like are preferable. As specific pigment preferably usable, the following pigments can be given.

As pigment for magenta or red, for example, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222 and the like are given.

As pigment for orange or yellow, for example, C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, C.I. Pigment Yellow 138 and the like are given.

As pigment for green or cyan, for example, C.I. Pigment Blue 15, C.I. Pigment Blue 15:2, C.I. Pigment Blue 15:3, C.I. Pigment Blue 16, C.I. Pigment Blue 60, C.I. Pigment Green 7 and the like are given.

For these pigments, a pigment dispersion may be used. As a usable pigment dispersion, for example, a surfactant such as higher fatty acid salt, alkyl sulfate salt, alkyl ester sulfate salt, alkyl sulfonate salt, sulfosuccinate salt, naphthalene sulfonate salt, alkyl phosphate salt, polyoxyalkylenealkylether phosphate salt, polyoxyalkylenealkylphenyl ether, polyoxyethylene polyoxypropyleneglycol, glycerin ester, sorbitan ester, polyoxyethylene fatty acid amide and amine oxide, or a block copolymer and a random copolymer each of which is made up of two or more monomers selected from styrene, a styrene derivative, a vinylnaphthalene derivative, acrylic acid, an acrylate derivative, maleic acid, a maleate derivative, itaconic acid, an itaconate derivative, fumaric acid and a fumarate derivative, and salts thereof can be given.

With regard to a dispersion method of the pigment, means thereof is not particularly limited. However, for example, a ball mill, a sand mill, an attritor, a roll mill, an agitator, a Henschel mixer, a colloid mill, an ultrasonic homogenizer, a pearl mill, a wet type jet mill, a paint shaker and the like are usable.

To use a centrifuging machine and to use a filter are also preferred methods for the purpose of eliminating coarse particles of a pigment dispersion according to the present invention.

A mean particle diameter of the pigment in the pigment ink is selected in consideration of the stability, image density, glossiness, light resistance thereof in the ink. In addition, in the inkjet recording method of the present invention, it is preferable to select the particle diameter also from viewpoints of improving the gloss and improving the texture. Although reasons that the selection of the particle diameter promotes the improvement of the gloss and the improvement of the texture in the present invention are uncertain, it is assumed that the reasons are associated with the fact that the pigment in the image is in a state of being dispersed into the coating film where the fine particles of the thermoplastic resin are melted. In the case of aiming at high-speed processing, the fine particles of the thermoplastic resin must be melted and formed into the coating film in a short time, and further, the pigment must be dispersed into the coating film sufficiently. At this time, the surface area of the pigment has a great influence, and therefore, it is assumed that the mean-particle diameter has the optimum range.

(Water-Soluble Organic Solvent)

It is preferable that an aqueous ink composition as a preferred embodiment as the pigment ink be combined with a water-soluble organic solvent.

As the water-soluble organic solvent, for example, mentioned can be alcohols (for example, methanol, ethanol, propanol, isopropanol, butanol, isobutanol, secondary butanol, tertiary butanol, pentanol, hexanol, cyclohexanol, benzyl alcohol, and the like), polyvalent alcohols (for example, ethyleneglycol, diethyleneglycol, triethyleneglycol, polyethyleneglycol, propyleneglycol, dipropyleneglycol, polypropyleneglycol, butyleneglycol, hexanediol, pentanediol, glycerin, hexanetriol, thiodiglycol, and the like), polyvalent alcohol ethers (for example, ethyleneglycol monomethylether, ethyleneglycol monoethylether, ethyleneglycol monobutylether, diethyleneglycol monomethylether, diethyleneglycol monomethylether, diethyleneglycol monobutylether, propyleneglycol monomethylether, propyleneglycol monobutylether, ethyleneglycol monomethylether acetate, triethyleneglycol monomethylether, triethyleneglycol monoethylether, triethyleneglycol monobutylether, ethyleneglycol monophenylether, propyleneglycol monophenylether, and the like), amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine, tetramethylpropylenediamine, and the like), amides (for example, formamide, N,N-dimethylformamide, N,N-dimethylacetamide, and the like), heterocycles (for example, 2-pyrrolidone, N-methyl-2-pyrrolidone, cyclohexylpyrrolidone, 2-oxazolidone, 1,3-dimethyl-2-imidazolidinone, and the like), sulfoxides (for example, dimethylsulfoxide and the like), sulfones (for example, sulforane and the like), urea, acetonitrile, acetone, and the like). The polyvalent alcohols can be given as a preferable water-soluble organic solvent. Moreover, it is particularly preferable to combine the polyvalent alcohol and the polyvalent alcohol ether.

The water-soluble organic solvents may be used alone or in combination. An added amount of the water-soluble organic solvent into the ink is 5 to 60 mass % in total, and preferably 10 to 35 mass %.

(Fine Particle of Thermoplastic Resin)

To the ink composition, the fine particles of the thermoplastic resin, a viscosity adjuster, a surface tension adjuster, a specific resistance adjuster, a film forming agent, a dispersant, a surfactant, an ultraviolet ray absorbent, an anti-oxidant, an anti-color fading agent, a mildewproofing agent, an anti-rusting agent and the like are appropriately added for the purpose of improvements of the jetting stability, compatibility of a print head and an ink cartridge, storage stability, image permanence and other various performances.

In particular, it is preferable to add the fine particles of the thermoplastic resin because the gloss of the image is improved. With regard to the fine particles of the thermoplastic resin, the types thereof already described in the explanation of the thermoplastic resin addable onto the surface layer of the recording medium P or the fine particles thereof are usable. In particular, it is preferable to apply one that does not cause thickening, precipitation and the like even if being added to the recording ink. The mean particle diameter of the fine particles of the thermoplastic resin is preferably 0.5 μm or less, more preferably, is selected within a range of 0.2 times to twice the mean particle diameter of the pigment in the recording ink. Then, this is preferable in terms of the stability. The fine particles of the thermoplastic resin to be added are preferably ones to be melted and softened within a range of 50 to 200° C.

(Ink Composition)

With regard to the ink composition, 40 mPa·s or less is preferable as viscosity thereof at the time of flying, and 30 mPa·s or less is more preferable. 20 mN/m or more is preferable as surface tension of the ink composition at the time of flying, and 30 to 45 mN/m is more preferable.

A solid concentration of the pigment in the recording ink can be selected within a range of 0.1 to 10 mass %. In order to obtain a photographic image, it is preferable to use so-called dark and light inks in which concentrations of pigment solid contents are varied individually, and is particularly preferable to individually use dark and light inks of yellow, magenta, cyan and black. Moreover, it is preferable to also use special inks of red, green, blue and the like according to needs in terms of the color reproduction.

[Preparation of Pigment Ink Set]

A preparation method of the recording ink for use in this embodiment will be described below by taking specific examples.

(Preparation of Pigment Dispersion)

<Preparation of Yellow Pigment Dispersion>

| | |
|---|---|
| C.I. Pigment Yellow 74 | 20 mass % |
| Styrene-acrylic acid copolymer (molecular weight of | 12 mass % |
| 10,000, acid value of 120) | |
| Diethyleneglycol | 15 mass % |
| Ion-exchange water | 53 mass % |

The above-described respective additives were mixed together, dispersed by using a horizontal type bead mill (System Zeta Mini made by Ashizawa Finetech Ltd.) in which zirconia beads of 0.3 mm were filled at a volume fraction of 60%, and a yellow pigment dispersion was thus obtained. A mean particle diameter of the obtained yellow pigment was 112 nm.

<Preparation of Magenta Pigment Dispersion>

| | |
|---|---|
| C.I. Pigment Red 122 | 25 mass % |
| Joncryl 61 (acrylic-styrene resin prepared by | 18 mass % as |
| Johnson Polymer Corporation) | solid content |
| Diethyleneglycol | 15 mass % |
| Ion-exchange water | 42 mass % |

The above-described respective additives were mixed together, dispersed by using the horizontal type bead mill (System Zeta Mini made by Ashizawa Finetech Ltd.) in which the zirconia beads of 0.3 mm were filled at the volume rate of 60%, and a magenta pigment dispersion was thus obtained. A mean particle diameter of the obtained magenta pigment was 105 nm.

<Preparation of Cyan Pigment Dispersion>

| | |
|---|---|
| C.I. Pigment Blue 15:3 | 25 mass % |
| Joncryl 61 (acrylic-styrene resin prepared by | 15 mass % |
| Johnson Polymer Corporation) | as solid content |
| Glycerin | 10 mass % |
| Ion-exchange water | 50 mass % |

The above-described respective additives were mixed together, dispersed by using the horizontal type bead mill (System Zeta Mini made by Ashizawa Finetech Ltd.) in which the zirconia beads of 0.3 mm were filled at the volume fraction of 60%, and a cyan pigment dispersion was thus obtained. A mean particle diameter of the obtained cyan pigment was 87 nm.

<Preparation of Black Pigment Dispersion>

| | |
|---|---|
| Carbon black | 20 mass % |
| Styrene-acrylic acid copolymer | 10 mass % |
| (molecular weight of 7,000, acid value of 150) | |
| Glycerin | 10 mass % |
| Ion-exchange water | 60 mass % |

The above-described respective additives were mixed together, dispersed by using the horizontal type bead mill (System Zeta Mini made by Ashizawa Finetech Ltd.) in which the zirconia beads of 0.3 mm were filled at the volume fraction of 60%, and a black pigment dispersion was thus obtained. A mean particle diameter of the obtained black pigment was 75 nm.

(Preparation of Pigment Ink Set)

<Preparation of Dark Yellow Ink>

| | |
|---|---|
| Yellow pigment dispersion | 15 mass % |
| Ethyleneglycol | 20 mass % |
| Diethyleneglycol | 10 mass % |
| Surfactant (Surfynol 465 prepared by Nisshin | 0.1 mass % |
| Chemical Industry Co., Ltd.) | |
| Ion-exchange water | 54.9 mass % |

The above respective compositions were mixed, agitated, filtered by means of the 1-μm filter, and dark yellow ink as an aqueous pigment ink of the present invention was thus prepared. A mean particle diameter of the pigment in the ink concerned was 120 nm, and surface tension γ thereof was 36 mN/m.

<Preparation of Dark Magenta Ink>

| | |
|---|---|
| Magenta pigment dispersion | 15 mass % |
| Ethyleneglycol | 20 mass % |
| Diethyleneglycol | 10 mass % |
| Surfactant (Surfynol 465 prepared by Nisshin | 0.1 mass % |
| Chemical Industry Co., Ltd.) | |
| Ion-exchange water | 54.9 mass % |

The above respective compositions were mixed, agitated, filtered by means of the 1-μm filter, and dark magenta ink as an aqueous pigment ink of the present invention was thus prepared. A mean particle diameter of the pigment in the ink concerned was 113 nm, and surface tension γ thereof was 35 mN/m.

<Preparation of Light Magenta Ink>

| | |
|---|---|
| Magenta pigment dispersion | 3 mass % |
| Ethyleneglycol | 25 mass % |
| Diethyleneglycol | 10 mass % |
| Surfactant (Surfynol 465 prepared by Nisshin | 0.1 mass % |
| Chemical Industry Co., Ltd.) | |
| Ion-exchange water | 61.9 mass % |

The above respective compositions were mixed, agitated, filtered by means of the 1-μm filter, and light magenta ink as an aqueous pigment ink of the present invention was thus prepared. A mean particle diameter of the pigment in the ink concerned was 110 nm, and surface tension γ thereof was 37 mN/m.

<Preparation of Dark Cyan Ink>

| | |
|---|---|
| Cyan pigment dispersion | 10 mass % |
| Ethyleneglycol | 20 mass % |
| Diethyleneglycol | 10 mass % |
| Surfactant (Surfynol 465 prepared by Nisshin | 0.1 mass % |
| Chemical Industry Co., Ltd.) | |
| Ion-exchange water | 59.9 mass % |

The above respective compositions were mixed, agitated, filtered by means of the 1-μm filter, and dark cyan ink as an aqueous pigment ink of the present invention was thus prepared. A mean particle diameter of the pigment in the ink concerned was 95 nm, and surface tension γthereof was 36 mN/m.

<Preparation of Light Cyan Ink>

| | | |
|---|---|---|
| Cyan pigment dispersion | 2 | mass % |
| Ethyleneglycol | 25 | mass % |
| Diethyleneglycol | 10 | mass % |
| Surfactant (Surfynol 465 prepared by Nisshin | 0.2 | mass % |
| Chemical Industry Co., Ltd.) | | |
| Ion-exchange water | 62.8 | mass % |

The above respective compositions were mixed, agitated, filtered by means of the 1-μm filter, and light cyan ink as an aqueous pigment ink of the present invention was thus prepared. A mean particle diameter of the pigment in the ink concerned was 92 nm, and surface tension γ thereof was 33 mN/m.

<Preparation of Dark Black Ink>

| | |
|---|---|
| Black pigment dispersion | 10 mass % |
| Ethyleneglycol | 20 mass % |
| Diethyleneglycol | 10 mass % |
| Surfactant (Surfynol 465 prepared by Nisshin | 0.1 mass % |
| Chemical Industry Co., Ltd.) | |
| Ion-exchange water | 59.9 mass % |

The above respective compositions were mixed, agitated, filtered by means of the 1-μm filter, and dark black ink as an aqueous pigment ink of the present invention was thus prepared. A mean particle diameter of the pigment in the ink concerned was 85 nm, and surface tension γ thereof was 35 mN/m.

<Preparation of Light Black Ink>

| | | |
|---|---|---|
| Black pigment dispersion | 2 | mass % |
| Ethyleneglycol | 25 | mass % |
| Diethyleneglycol | 10 | mass % |
| Surfactant (Surfynol 465 prepared by Nisshin | 0.1 | mass % |
| Chemical Industry Co., Ltd.) | | |
| Ion-exchange water | 62.9 | mass % |

The above respective compositions were mixed, agitated, filtered by means of the 1-μm filter, and light black ink as an aqueous pigment ink of the present invention was thus prepared. A mean particle diameter of the pigment in the ink concerned was 89 nm, and surface tension γ thereof was 36 mN/m.

[Colorless Ink]

The colorless ink stands for ink that does not substantially contain the color material, and it is preferable that the variation of ΔE of the image portion, which is caused by the existence of the colorless ink, be 3 or less. Content components of the colorless ink either may be dissolved uniformly or may be present in a heterogeneous dispersion system. Moreover, though even colorless ink obtained by removing the color material from the recording ink for use is usable, it is preferable to add the following. As addable matter, resin in a dissolved state in an aqueous system, resin in a dispersed state in the aqueous system, resin in a dissolved state in an organic solvent system, resin in a dispersed state in the organic solvent system and the like can be given; however, the resin in the dissolved state in the aqueous system and the resin in the dispersed state in the aqueous system are preferable.

The resin in the dissolved state in the aqueous system includes, for example, polyvinyl alcohol, gelatin, polyethylene oxide, polyvinyl pyrrolidone, polyacrylic acid, polyacrylamide, polyurethane, dextran, dextrin, carrageenan (κ, l, λ, etc.), agar, pullulan, water-soluble polyvinyl butyral, hydroxyethylcellulose, carboxymethylcellulose, and the like.

The resin in the dispersed state in the aqueous system is preferably thermoplastic resin, and for example, includes polycarbonate, polyacrylonitrile, polystyrene, polyacrylic acid, polymethacrylic acid, polyvinyl chloride, polyvinylidene chloride, polyvinyl acetate, polyester, polyamide, polyether, copolymers thereof, and salts thereof. Among them, preferable are a styrene-acrylic acid ester copolymer, a methacrylic acid ester-acrylic acid ester copolymer, a vinyl chloride-vinyl acetate copolymer, a vinyl chloride-acrylic acid ester copolymer, an ethylene-vinyl acetate copolymer, an ethylene-acrylic acid ester copolymer, and SBR latex. For the thermoplastic resin or the fine particles thereof, plural polymers different in monomer composition, particle diameter and polymerization degree may be mixed together for use.

Moreover, in the case of mixing the recording ink and the colorless ink together, it is desirable that an aggregation of the color material should not occur substantially, and specifically, that a rate of light absorbance change should be less than 5%. As an example of the above-described case, the recording ink and the colorless ink are mixed together on the recording medium P. Moreover, in the case of supplying the colorless ink and the recording ink from the inkjet nozzles, the recording medium P is sometimes contaminated by both of the inks though this is not preferable. Furthermore, there is a case of using the same recording head 22 for the recording ink and the colorless ink for each image forming mode. Even in such cases, the lowering of the image quality and the lowering of the gloss must not occur. When this point was studied, it was found that the lowering of the image quality and the lowering of the gloss did not occur in the case where, when the recording ink and the colorless ink were mixed together, the light absorbance change was 5% or less with respect to light absorbance immediately thereafter. More specifically, 10 ml of the colorless ink was added to 40 ml of the recording ink, followed by mixing, and light absorbance of a supernatant portion immediately thereafter was measured. Next, the above-described mixed solution was hermetically sealed, stored for 3 days under an environment of 25° C., and the light absorbance of the supernatant portion was measured in a similar way. Then, both of the mixed solutions were compared with each other. Note that, with regard to each light absorbance of the ink, the maximum value of the light absorbance within a range of 400 nm to 700 nm was measured by using a spectrophotometer (U-3200 made by Hitachi, Ltd.). Then, based on this value, the rate of the light absorbance change was calculated as (light absorbance before storage−light absorbance after storage)/(light absorbance before storage)×100 (%). For example, the light absorbance changes of the above-described respective recording inks resulted as follows: 1.0% in dark yellow ink, 1.3% in dark magenta ink; 0.7% in light magenta ink; 0.2% in dark cyan ink; 0.5% in light cyan ink; 0.9% in dark black ink; and 1.2% in light black ink.

The ink jetting of the colorless ink is performed by using the recording head 22 similar to that for use in the recording ink. A preferred embodiment in this case includes the ink jetting to be performed simultaneously with the ink jetting of the recording ink. For example, it is desirable that eight recording heads 22 be prepared as described above, and be individually used for Y, M, C, K, LC, LM, LK and the colorless ink, and that the jetting of the colorless ink be performed simultaneously with the image formation by the recording heads 22. However, in this case, the recording ink and the colorless ink are sometimes mixed together on the recording medium P before being absorbed in the media, and accordingly, a degree of freedom in prescription of the recording ink and the colorless ink is lowered. In order to avoid this, spots of jetting the recording ink and spots of jetting the colorless ink may be provided separately from each other, and after the jetting of either of the ink is completed, the other one may be jetted.

[Preparation of Colorless Ink]

Here, preparation of the colorless ink will be described by taking a specific example.

Resin (acrylic ester copolymer: Tg of 75° C., mean particle diameter of 0.2 μm) 2.0 mass % as solid content

| | | |
|---|---|---|
| Ethyleneglycol | 22.0 | mass % |
| Glycerin | 8.0 | mass % |
| Triethyleneglycol monobutylether | 5.0 | mass % |
| 2-pyrrolidone | 2.0 | mass % |
| Surfynol 465 (prepared by Nisshin Chemical Industry | 0.5 | mass % |
| Co., Ltd.) | | |

Pure water was added to the above, and the colorless ink was finished to reach 100 mass %.

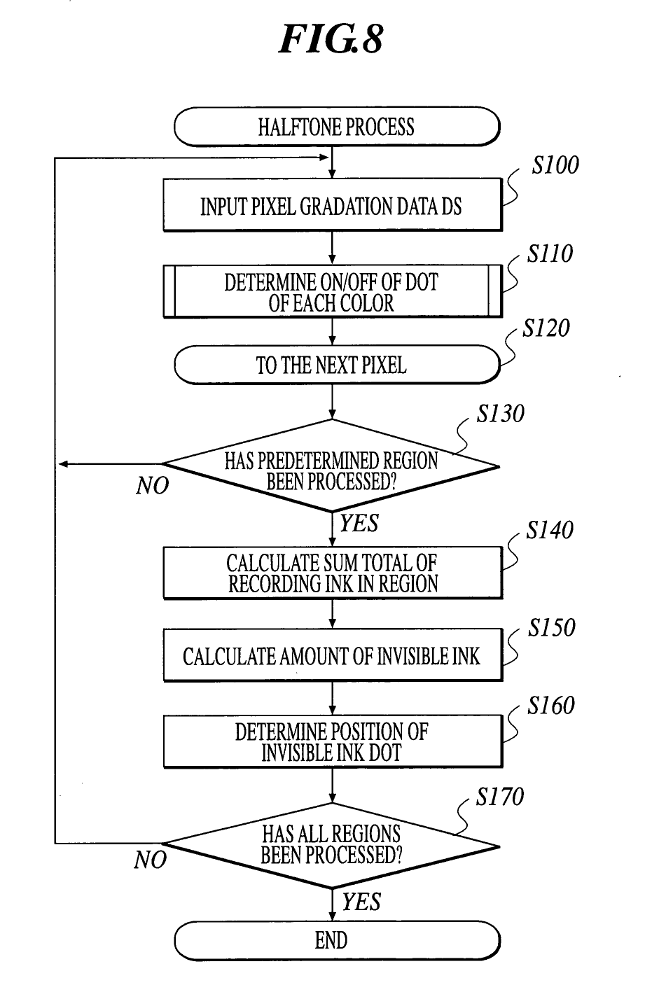

Next, the inkjet recording method will be described while describing a calculation process of the data for the recording ink by the halftone module 206 and a calculation process of the data for the colorless ink by the colorless ink calculation module 207 by referring to FIG. 8. FIG. 8 is a flowchart showing an outline of the process of the halftone module 206.

As shown in FIG. 8, when the image formation is started, the printer driver 203 sequentially scans the respective pixels from an upper left corner of one image, which is taken as an origin, based on image data inputted from the application program 201, and first creates gradation data DS (Y, M, C, K, LM, LC and LK, each having 8 bits) after color correction for each pixel in order along the scanning direction of the carriage 23 from the color gradation correction module 205 (Step S100).

Next, the printer driver 203 performs processing for determining on/off of a recording dot based on the gradation data DS (Step S110), and creates the gradation data DS of the next pixel (S120). This is repeated for all the pixels in a predetermined region (S130).

After the processing is performed for the predetermined region, a total adhered amount of the recording ink in the region concerned is obtained (S140), and based on this value, the adhered amount of colorless ink to be placed onto the region concerned is determined (S150). Specifically, the adhered amount of colorless ink is obtained so that the sum total of the adhered amounts of recording ink and colorless ink can reach a predetermined amount or more. Then, it is determined as to which pixel position the colorless ink is to be jetted in the region concerned (S160), and the above-described processing is repeated for all predetermined regions on the recording surface of the recording medium P (S170). As described above, the jetted positions of the colorless ink are determined for all the predetermined regions on the recording surface of the recording medium P. Accordingly, the colorless ink will be jetted also onto the blank portion onto which the recording ink is not jetted, and the gloss will be obtained also on the blank portion.

The predetermined region in this case is a unit area on the recording medium, on which the sum total of the adhered amounts of colorless ink and recording ink is to be maintained to be a certain amount or more. The minimum of the predetermined region is a one-pixel unit, and the maximum thereof is a full surface of the recording medium. However, it is obvious that, for the purpose of imparting the evenness of the gloss, an effect of defining the predetermined region is small when the full surface is taken as the unit. Meanwhile, when the one-pixel unit is defined as the predetermined region, the adhered amount of colorless ink will be controlled most finely. However, even if the adhered amount of colorless ink on one pixel is assumed to be 0, when the recording ink near a limit of the ink absorbing capacity of the recording medium are placed on all the pixels in the periphery thereof, it is advantageous in ink overflow not to place the colorless ink on the pixel concerned. Hence, a desirable size exists in the size of the unit area.

Specifically, with regard to the size of the unit area, as a result of a study of the inventor of the present invention, it has been found that, in the case of improving the evenness of the gloss of the recording surface, 2 mm or less is essential as the maximum unit to be controlled, and 0.5 mm square is more preferable. Resolving power of a human eye has the highest sensitivity at an interval of 0.5 mm when a distance of the eye to the recording medium is set at approximately 30 cm. Hence, in the case of ensuring evenness of a black density of the recording surface by means of dots of the recording head, it is necessary that the dots be distributed at a spatial frequency higher than the above.

However, it has been found that the resolving power of the human eye is not very high for characteristics such as the gloss, and that a very large feeling of wrongness does not occur even if portions with the gloss and portions without the gloss are distributed uniformly at an interval of approximately 1 mm. Therefore, if the evenness of the gloss is considered, it is preferable that the unit area be 1 mm square, and that the sum total of the adhered amounts of colorless ink and recording ink within the unit area be set at the predetermined amount or more. It is desirable that the sum total of the adhered amounts of colorless ink and recording ink in the case of defining the unit area as 1 mm square as described above be 2 cc/m² or more.

Moreover, a block formed of an aggregate of the n (n>1) pieces of pixels may also be defined as the unit area.

In general, in the case of printing an image having gradation, such as a photograph, by the inkjet mode, the number of gradations for each pixel is short, and accordingly, a halftone process using error diffusion and a dither matrix becomes necessary. In this case, when the area of the unit to be controlled is set as a unit of the dither matrix, data for the colorless ink can be calculated simultaneously with the halftone process, and this is efficient. In particular, the dither matrix is a technique for use when a high-speed output is desired though the image quality is not required very much, where an effect that the calculation of the adhered amount of colorless ink can be made at the high speed is large. The dither matrix is one taking a×b (=n) pixels in a usual image as one block and using the block as a unit for determining dot formation, where a is the number of pixels in the lateral direction and b is the number of pixels in the longitudinal direction. Specifically, the unit area of the adhered amounts of colorless ink and recording ink is set as the block formed of an aggregate of the n (n>1) pieces of pixels, and the adhered amounts of recording ink and colorless ink can be thus controlled correspondingly to the dither matrix.

Note that, in the case of setting the block formed of the aggregate of the n pieces (n>1) of pixels as the unit area, the block of the same pixels as those for the error diffusion is used for creating the data for the colorless ink; however, without being limited to this, the creation of the data for the colorless ink may be combined with the halftone process. Specifically, for example, the error diffusion is performed at 1080 dpi for a one-pixel unit to determine the jetted positions of the recording ink, and thereafter, the positions are divided into four (2×2)-pixel blocks to calculate the adhered amounts of recording ink, thus making it possible to determine the jetted positions of the colorless ink. Meanwhile, a dither process is used as the halftone process to determine recorded dots within the matrix concerned simultaneously with the dither process, and thereafter, the sum total of the jetted ink within the matrix concerned may be determined so as to reach a predetermined value. Moreover, blocks for the colorless ink may be made separately from the dither matrix, and the colorless ink may be calculated.

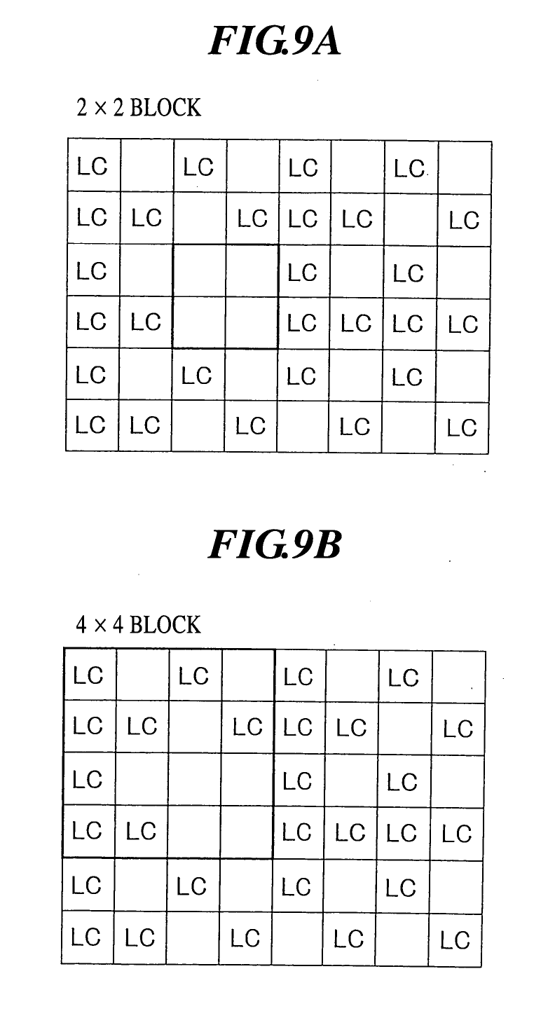

The blocks as the unit area for calculating the colorless ink are not limited to the above-described 2×2, and may be made to a larger size. In this case, the formation of the colorless ink dots can be determined while considering the adhered amount in a wider region. For example, as shown in FIG. 9A and FIG. 9B, when the sum total of the adhered amounts of colorless ink and recording ink is defined as 25% as a predetermined adhered amount, one dot of the colorless ink will be jetted onto each four-pixel block of FIG. 9A. Meanwhile, when the recording ink is calculated in a region of FIG. 9B, which is wider than the four-pixel block, it is seen that the sum total of the adhered amounts is 50% even before the colorless ink is jetted. Hence, when the determination is made based on the 2×2 pixel block, one dot of the colorless ink will be placed in FIG. 9A, but no dot will be placed in FIG. 9B. Characteristics such as the gloss appear as average characteristics of the entire region having some area, and accordingly, even if the colorless ink is determined not to be placed in the case of FIG. 9B, an influence therefrom hardly occurs. In fact, there was no difference in gloss between the case where the block was formed of 16 (4×4) pixels and the amount of recording ink and colorless ink therein was set at 25% and the case where the block was formed of 2×2 pixels. It is obvious that the case of FIG. 9B is more economical since the adhered amount of colorless ink can be reduced more effectively.

Note that, though the square in which longitudinal sides and lateral sides were equal to each other was used as the block of the pixels here, a block shape can be selected appropriately from a rectangle, a rhombus and the like without being limited to the above. Furthermore, it is not necessary that all the blocks be formed into the same shape with the same number of pixels, and the shapes of the blocks may differ depending on a place of the image within a range where a difference between the maximum number and the minimum number does not substantially exceed a double therebetween. This is similar to a concept of creating a screen pattern in so-called halftone dot formation in printing.

Then, when the calculation processes for the data for the recording ink and the data for the colorless ink are finished as shown in FIG. 8, the image forming apparatus 200 outputs the data for the recording ink and the data for the colorless ink to the control circuit 100 of the inkjet printer 1. Based on the data for the recording ink and the data for the colorless ink, the control circuit 100 controls the conveyor motor 101, the carriage drive motor 231, the recording heads 22 and the like to convey the recording medium P, and to jet the recording ink and the colorless ink from the recording heads 22 while driving the carriage 23.

Thereafter, when the recording medium P on which the image is formed is conveyed to the fixing unit 4, the control circuit 100 allows the heat source 43 to generate heat to reach a predetermined heating temperature based on a detection result of the temperature sensor 413 while controlling the heating roller drive motor 44 so that the heating roller 41 can convey the recording medium P. In such a way, the image is fixed onto the recording medium P. Then, in this case, the recording ink, the colorless ink and the thermoplastic resin on the recording medium P are melted and turned into a coating film, and accordingly, the gloss is improved.

Note that, though the method of fixing the image by heating is applied as the fixing process in this embodiment, the image may also be fixed by pressurization as the fixing process, and further, the image may also be fixed by both the heating and the pressurization.

The fixing process may be performed continuously with the image formation after the image is formed, and may be performed collectively after a certain amount of images are formed. In the present invention, it is preferable to implement the fixing process within a range of a fixed time after the image formation and the jetting of the colorless ink from a viewpoint of the color reproduction. It is preferable to implement the fixing process within 5 seconds or more to 10 minutes or less after the image formation and the jetting of the colorless ink, and more preferable to implement the fixing process in 10 seconds or more to 5 minutes or less.

In the above-described method, it is particularly preferable to perform the fixing process with heat for the image in which the inorganic pigment and the thermoplastic resin exist mixedly or in which both of them exist adjacent to each other. In this case, it is particularly preferable to partially or completely melt the thermoplastic resin, and further to turn the thermoplastic resin into the coating film.

For the fixing process with heat, only energy enough to exert the effect of the present invention sufficiently is required. When higher energy more than necessary is given, deformation and the like of the support occur to rather deteriorate the glossiness, and accordingly, this is not preferable. Heating temperature just needs to be temperature at which the image can be smoothened, and preferably within a range of 60 to 200° C., and more preferably within a range of 80 to 160° C.

The heating performed in the fixing process may be performed either by a heating apparatus built in the inkjet printer 1, such as the fixing unit 4 illustrated in this embodiment, or by a heating apparatus provided separately. It is preferable to use, as the heating apparatus, a heating roller, a heating belt, or a system formed by combining these because these devices eliminate an occurrence of unevenness, are small in terms of space, and are suitable for performing continuous processing. Moreover, for these heating apparatuses, a fixing machine with heat for an electronic photograph can be diverted, and these heating apparatuses are advantageous in terms of cost.

Moreover, as a fixing machine for fixing the image by implementing both the heating and the pressurization, for example, one for implementing the heating and pressurization processes by passing the recording medium between a heating roller building a heating element therein and a pressing roller, one for implementing the heating and the pressurization by sandwiching the recording medium between two heating rollers, and the like are given.

Conveying speed of the recording medium in the case of using the heating roller is preferably in a range of 1 to 15 mm/second. This is preferable from a viewpoint of the image quality as well as a viewpoint of high-speed processability. In order to obtain higher texture and gloss, it is preferable to perform the pressurization simultaneously with the heating, or immediately thereafter. As pressure for the pressurization, a range of 9.8×10⁴ to 4.9×10⁶ Pa is preferable. This is because the pressurization promotes growth of the coating film.

As described above, according to the inkjet recording method of this embodiment, the recording ink is jetted onto the recording medium P, the colorless ink for improving the gloss is jetted onto the recording medium P, and the image is thus formed. Accordingly, even if the gloss of the image-formed regions is improved by the color materials contained in the recording ink, the colorless ink is jetted onto the blank portion and the highlighted portion in which the adhered amount of recording ink is small, thus making it possible to improve the gloss of these portions. In particular, the adhered amount of colorless ink per unit area is determined in response to the adhered amount of recording ink per unit area. Accordingly, the gloss on the recording surface of the recording medium can be made even, and the feeling of wrongness owing to the unevenness of the gloss can be solved.

Note that, naturally, the present invention is not limited to the above-described first embodiment, and is modifiable as appropriate.

For example, in the first embodiment, the method of making the calculation so that the sum total of the adhered amounts of recording ink and colorless ink per unit area can be a predetermined amount or more in the case of determining the adhered amount of colorless ink per unit area is illustrated. However, besides this, also used may be a method of making a calculation so that the jetted amount of colorless ink can become larger in a region where the adhered amount of recording ink per unit area is a predetermined amount or less than in a region where the adhered amount of recording ink is more than the predetermined amount.

Moreover, the first embodiment has a configuration in which the image forming apparatus 200 performs the process of the data for the colorless ink and the halftone process as a recording ink dot process. However, both of the processes may be performed by another apparatus, and may be performed individually by different apparatuses. A merit of separately performing the process of the data for the colorless ink and the halftone process as the recording ink dot process is that the halftone process is enabled to be processed by the printer driver of the image forming apparatus 200, a host personal computer and the like, and that the calculation for the colorless ink can be loaded in the inside of the inkjet printer 1. The halftone process is a process requiring a long time, and accordingly, it is frequent that a result of a calculation performed once is stored in a file, and later used repeatedly for outputs. Characteristics such as the gloss are sometimes affected by the ambient temperature and humidity, and when a file reflecting the temperature and the humidity at a certain point of time is created, the file becomes unusable for the output in a different temperature and humidity environment later on. In such a case, when the process of determining the amount of colorless ink is loaded in the inside of the printer, the same printing file becomes easily and repeatedly usable.

### Second Embodiment

A second embodiment according to the present invention will be described below. In the above-described first embodiment, the inkjet recording method of determining the adhered amount of colorless ink per unit area in response to the adhered amount of recording ink per unit area has been described. In this second embodiment, description will be made of an inkjet recording method of determining the adhered amount of colorless ink per unit area in response to the adhered amount of recording ink per unit area, and further determining the jetted positions of the colorless ink in response to the jetted positions of the recording ink. Note that, in the description below, the same reference numerals will be assigned to the same portions as those of the first embodiment, and description thereof will be omitted.

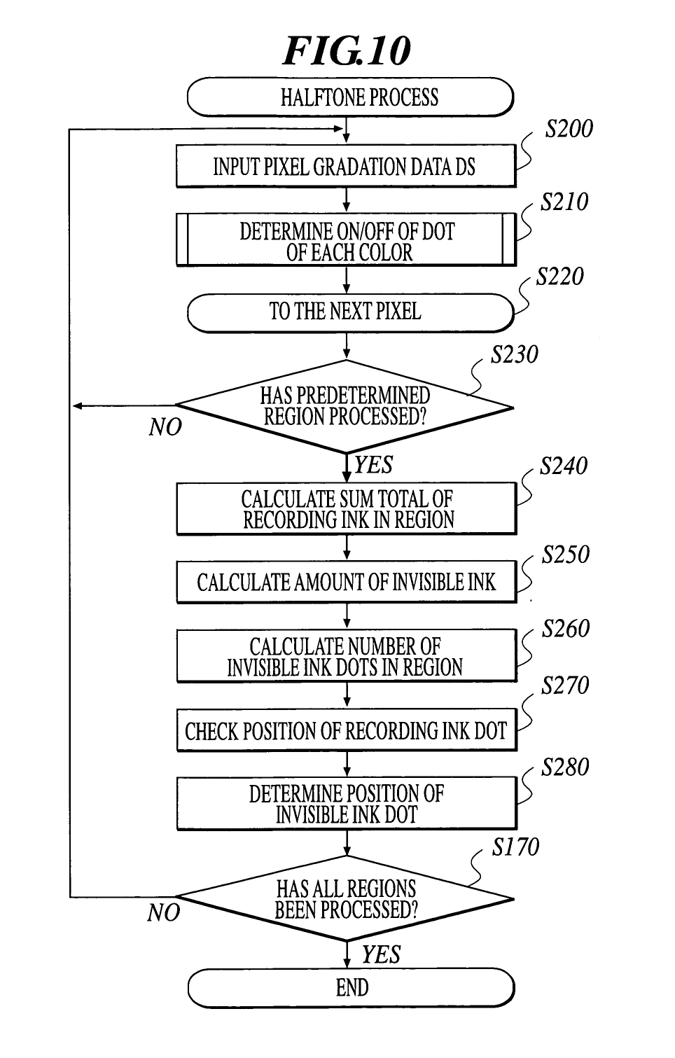

FIG. 10 is a flowchart showing an outline of a process of the halftone module 206 according to the second embodiment. Referring to FIG. 10, description will be made of a calculation process of the data for the recording ink by the halftone module 206 and a calculation process of the data for the colorless ink by the colorless ink calculation module 207.

As shown in FIG. 10, when the image formation is started, the printer driver 203 sequentially scans the respective pixels from the upper left corner of one image, which is taken as an origin, based on the image data inputted from the application program 201, and first creates the gradation data DS (Y, M, C, K, LM, LC and LK, each being an 8-bit value) after the color correction for each pixel in order along the scanning direction of the carriage 23 from the color gradation correction module 205 (Step S200).

Next, the printer driver 203 performs the processing for determining on/off of the recording dot based on the gradation data DS (Step S210), and creates the gradation data DS of the next pixel (S220). This is repeated for all the pixels in the unit area (S230).

After the processing is performed for the unit area, a total adhered amount of the recording ink in a region concerned is obtained (S240), and based on this value, the adhered amount of colorless ink to be placed onto the region concerned is determined (S250). Specifically, the adhered amount of colorless ink is obtained so that the sum total of the adhered amounts of recording ink and colorless ink can reach a predetermined amount or more. Then, it is calculated as to how large number of dots in the unit area the colorless ink is to be adhered onto based on the determined adhered amount of colorless ink (S260).

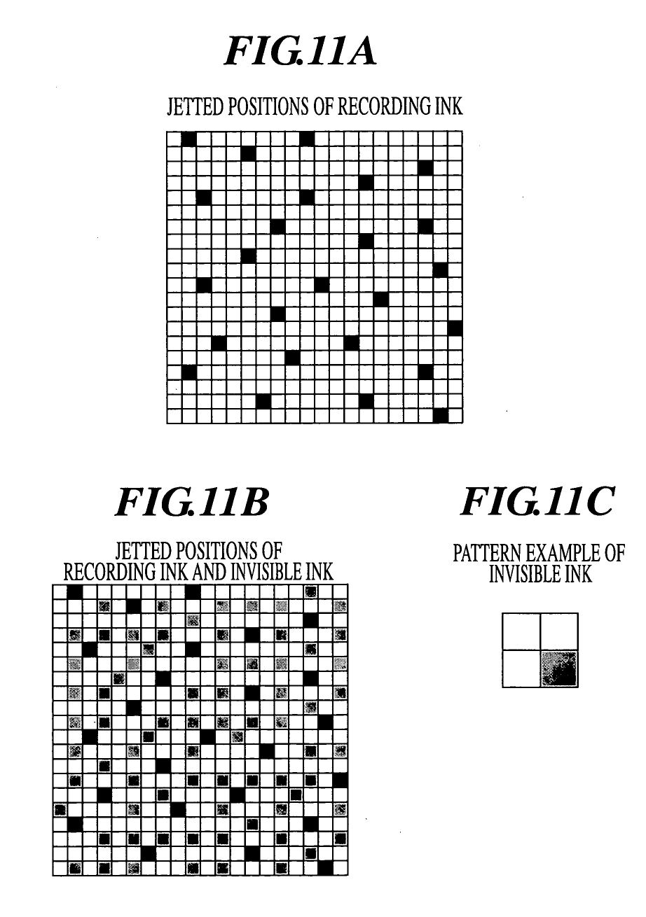

Subsequently, the printer driver 203 checks dot positions serving as the jetted positions of the recording ink (Step S270), and determines dot positions serving as the jetted positions of the colorless ink in response to the jetted positions of the recording ink and the number of dots of the colorless ink (Step S280). For example, the jetted positions of the colorless ink are determined so that the jetted positions of the recording ink and the jetted positions of the colorless ink in the unit area cannot become positions adjacent to or overlapped on each other. A specific example of the above will be described with reference to FIGS. 11 to 14. In this specific example, a four (2×2)-pixel block is used as the unit area. Note that, in FIG. 11 to FIG. 14, a square painted black is a jetted position of the recording ink, a square painted light is a jetted position of the colorless ink, and a non-painted square is a position without ink adhered thereto.

In FIG. 11 to FIG. 13, the sum total of the adhered amounts of colorless ink and recording ink is set at 25%. Accordingly, when the recording ink is not jetted onto the four-pixel block, as shown in FIG. 1C, one dot of the colorless ink is jetted onto a lower left pixel in the four-pixel block, and when the recording ink is jetted onto the four-pixel block, the colorless ink is not jetted onto the four-pixel block. In such a way, the jetted positions of the recording ink and the jetted position of the colorless ink are prevented from being overlapped on each other. Then, for example, when the recording ink is jetted onto jetted positions as shown in FIG. 11A, one dot of the colorless ink is jetted onto a four-pixel block onto which the recording ink is not jetted among the respective four-pixel blocks. In this case, when the colorless ink is jetted as shown in FIG. 1C, the colorless ink concerned sometimes becomes adjacent to a jetted position of the recording ink in an adjacent four-pixel block. Accordingly, the printer driver 203 refers to the jetted positions of the recording ink, and when the jetted position of the colorless ink becomes adjacent to upper, lower, left and right side thereof, varies the jetted position of the colorless ink from the lower left so as not to be adjacent to the jetted position of the recording ink, thereby determining the jetted position of the colorless ink (refer to FIG. 11B). Here, when the jetted position of the colorless ink becomes a position diagonal to the jetted position of the recording ink, this may be permitted since the overlap of both is small.

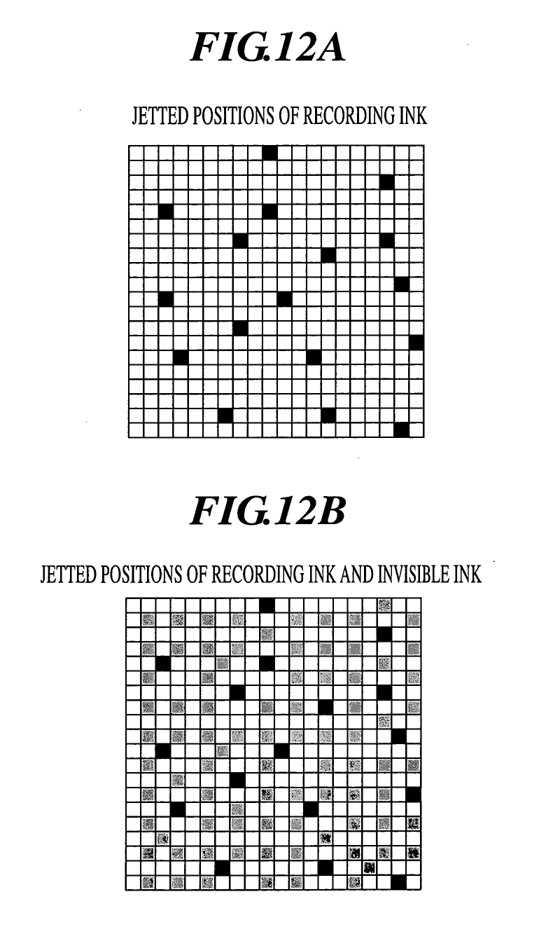

FIG. 12 is illustrations of the case where the jetted positions of the recording ink are less than those of FIG. 11 (refer to FIG. 12A). Also in FIG. 12, as in the case of FIG. 11, the jetted positions of the recording ink and the jetted positions of the colorless ink are adapted to be neither overlapped on each other nor adjacent to each other (refer to FIG. 12B).

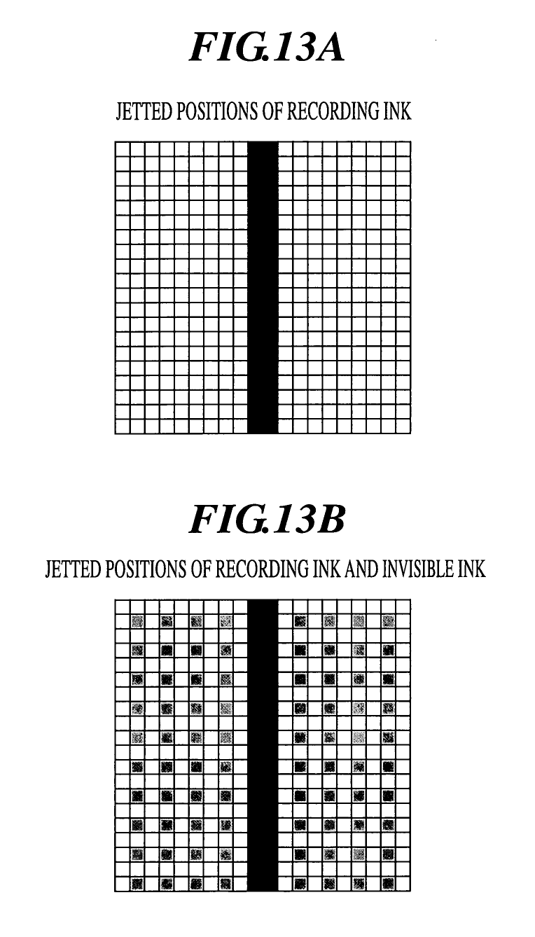

FIG. 13 is illustrations of the case where the jetted positions of the recording ink are linearly arrayed (refer to FIG. 13A). In such a linear pattern and the like, a bleeding of the dot is prone to be visually recognized, and accordingly, the jetted positions of the colorless ink are determined so as not to be adjacent to the recording ink as shown in FIG. 13B.

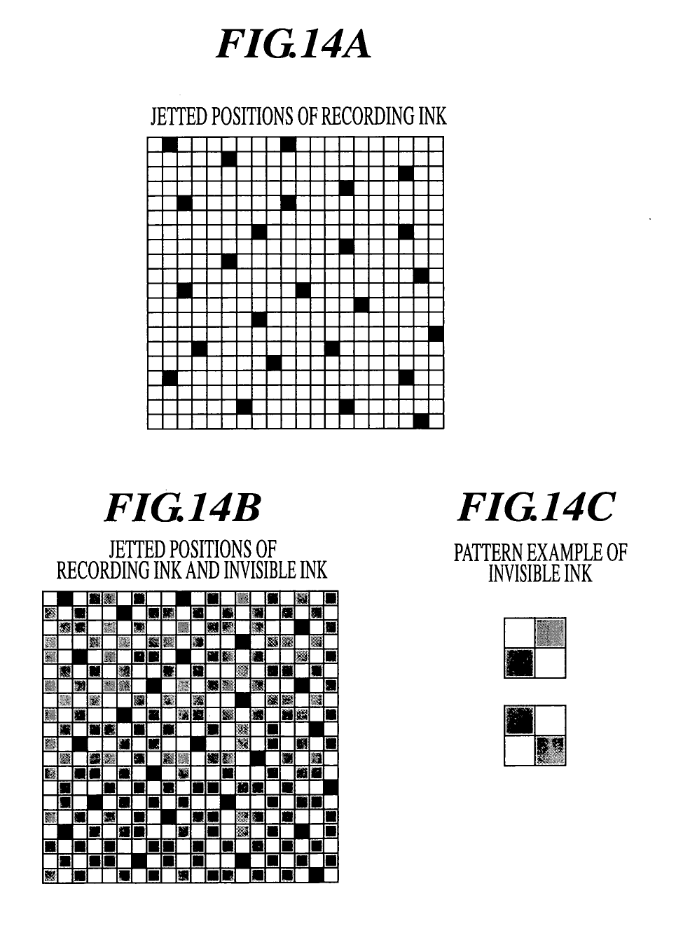

FIG. 14 is illustrations of the case where the sum total of the adhered amounts of colorless ink and recording ink are set at 50%. When the recording ink is not jetted onto the four-pixel block, as shown in FIG. 14C, only one dot of the colorless ink is jetted onto each of two pixels in the four-block pixel, which are arranged on a diagonal line. Here, while two types of arrangement patterns are illustrated in FIG. 14C, when the recording ink is jetted onto an adjacent four-pixel block, the arrangement pattern in which the pixels are not adjacent to the jetted positions of the recording ink concerned is selected. Meanwhile, when the recording ink is jetted onto the four-pixel block concerned, only one dot of the colorless ink is jetted onto one pixel located on a diagonal line thereof. Then, for example, when the recording is jetted onto jetted positions as shown in FIG. 14A, the colorless ink is jetted onto the jetted positions as shown in FIG. 14B.

Then, as shown in FIG. 10, the above-described processing is repeated for all the predetermined regions on the recording surface of the recording medium P (S290). As described above, the jetted positions of the colorless ink are determined for all the predetermined regions on the recording surface of the recording medium P, and accordingly, the colorless ink will be jetted also on the blank portion on which the recording ink is not jetted, and the gloss will be obtained also on the blank portion.

### EXAMPLE

### Example 1

In Example 1, an error diffusion method was used as the halftone process, and with regard to the calculation of the adhered amount of colorless ink, the total amount of recording ink and colorless ink was set to not less than the predetermined amount on a four-pixel unit made of two pixels in the longitudinal direction and two pixels in the lateral direction as one block. Recording conditions are as follows.

Recording resolution: Main scanning/sub-scanning 1080 dpi

Ink type: Dark and light cyan, dark and light magenta, dark and light black, yellow, and colorless ink

(eight in total)

Ink droplet: 6.7 μl

Main scanning speed: 705 mm/sec

Error diffusion resolution: 540 dpi

Number of error diffusion levels: 7

Ink control block (unit area): Longitudinally and

laterally two-by-two four pixels

Fixing temperature: 100° C.

Fixing pressure: 4 kg/cm²

Fixing time: 1.0 second

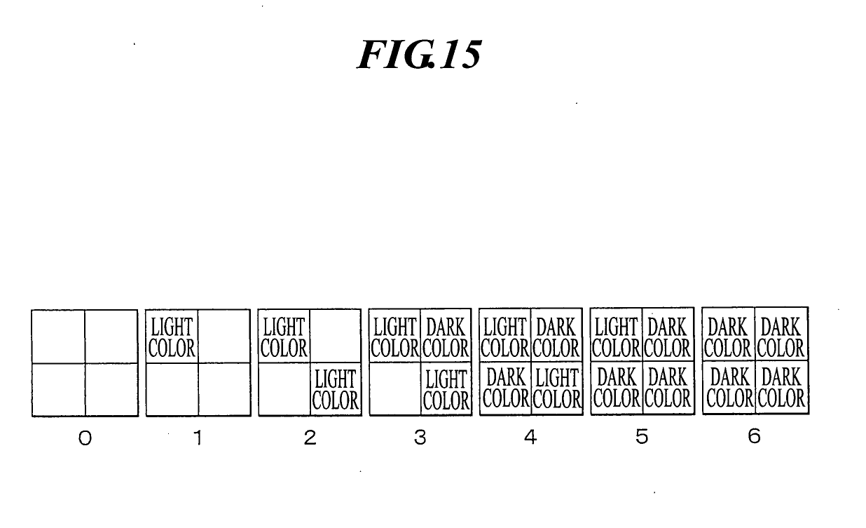

To gradation levels of 0 to 6 calculated by performing an error diffusion process as the halftone process by values obtained by dividing 540 dpi by seven, dark and light dots were assigned as shown in FIG. 15A. However, Y does not have a light color but has only a dark color, and accordingly, the light dots in the drawing were defined as the dark colors. Hence, the levels 4 to 6 come to have completely the same pattern, a multi-level processing of five levels of 0 to 4 was performed. With regard to the image data, patches of 33 gray gradations (in which data value are 0, 8, 16, 24 . . . , 248, 255) were defined as mixtures (so-called composite blacks) of the gray with all the recording inks of C, M, Y, K, LM, LC and LK, and the image was thus formed. With regard to the patches, gradation correction was made in advance for the image data so that a lightness (L* value) could be uniform from 0 (no ink) to 255 (the darkest patch), and amounts of the respective recording inks were balanced so than an a* value and a b* value could be substantially 0. A size of each patch was set at 4 cm square so as to make it possible to measure the gloss and a C value.

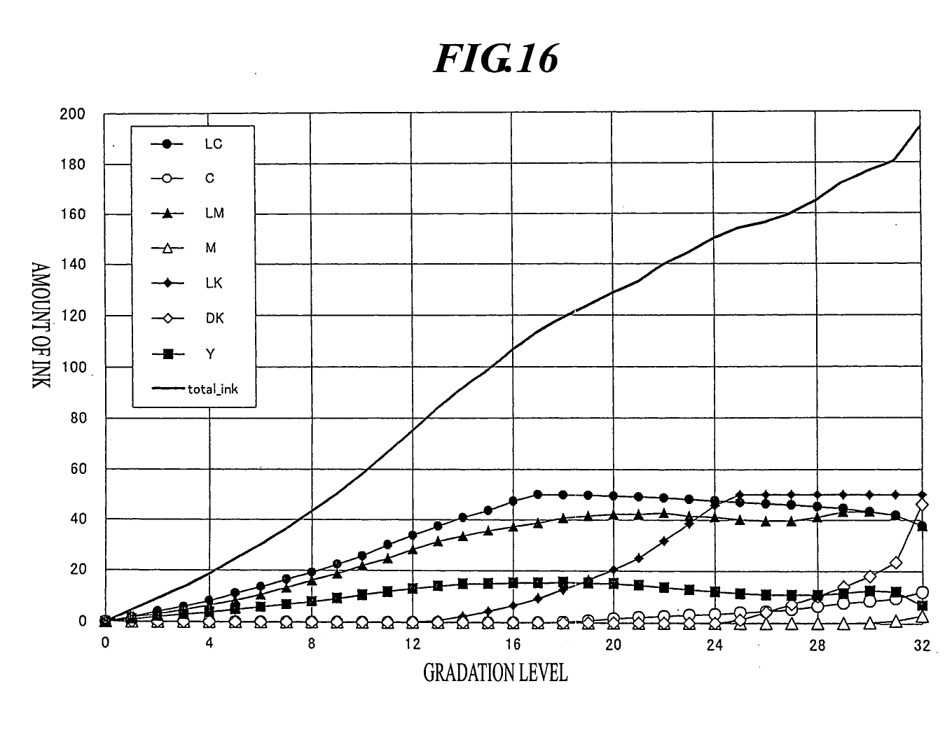

FIG. 16 shows a graph in which the ink amount of the patch of each gradation level was plotted for each ink. A percent value of an axis of ordinates is a ratio of the adhered amount of ink to the medium, where the case of placing any one of the ink droplets onto all the pixels was defined as 100%. In this case, the ink droplets become 6.7 μl for a pixel area of 23.5×23.5 μm² and the adhered amount becomes 12.1 cc/m².

With respect to this, some types of images in each of which the colorless ink dots were formed on the recording surface of the recording medium by jetting the colorless ink from the recording head 22 for the colorless ink simultaneously with usual recording were created while changing the amount of colorless ink.

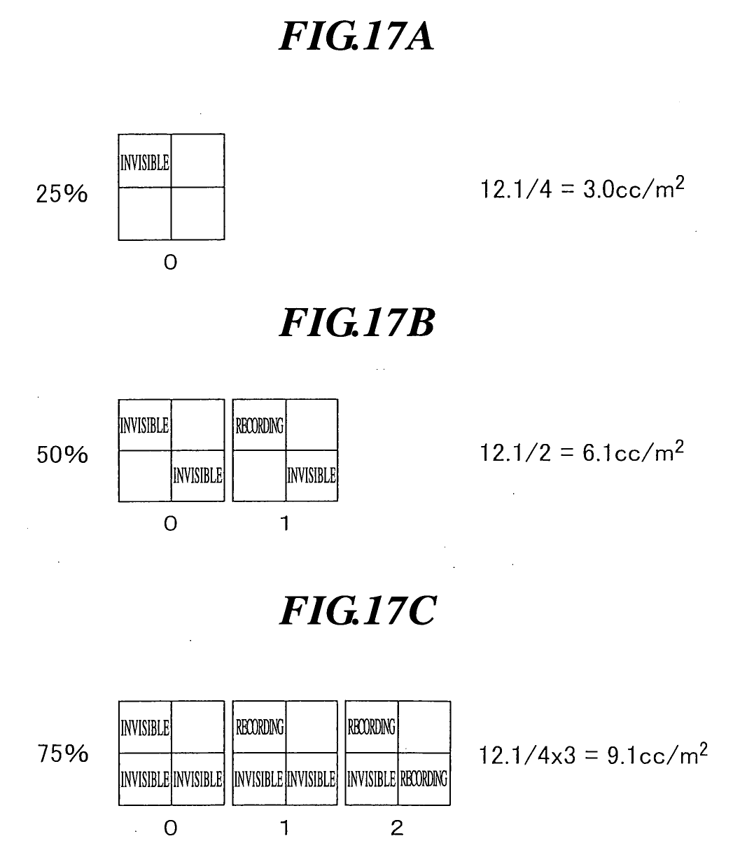

The sum total of the colorless ink and recording ink was changed from 12.5 to 100%. As shown in FIG. 17A, in the case of setting the sum total at 25%, when the recording ink is not present at all in the block of four pixels, the colorless ink is jetted onto an upper left pixel. When at least one droplet of any recording ink is placed on the block, the colorless ink is not placed. Specifically, it is only a block of which gradation level was calculated to be 0 that the colorless ink is to be placed thereonto. The adhered amount in this case becomes 3.0 cc/m².

In the case of setting the sum total at 50%, as shown in FIG. 17B, the colorless ink dots are jetted so that at least two droplets of the dots of the recording ink and the colorless ink can be placed onto each block. When two droplets of the recording ink are placed, the colorless ink dot is not formed. In the block of which gradation level was calculated to be 0, the colorless ink dots are formed on upper left and lower right pixels. In a block of which gradation level was calculated to be 1, the colorless ink dot is formed at a pixel position located on a diagonal line with respect to the recording ink. The adhered amount in this case becomes 6.1 cc/m².

In the case of setting the sum total at 75%, as shown in FIG. 17C, the colorless ink dots are jetted so that at least three droplets of the recording ink and the colorless ink are placed onto the block. When three droplets are placed, the colorless ink dot is not formed. The adhered amount in this case becomes 9.1 cc/m².

In the case of setting the sum total at 100%, at least one droplet of the recording ink or the colorless ink dot is adapted to be formed on every pixel without fail. Specifically, when the recording ink is jetted onto each pixel, the colorless ink is not jetted.

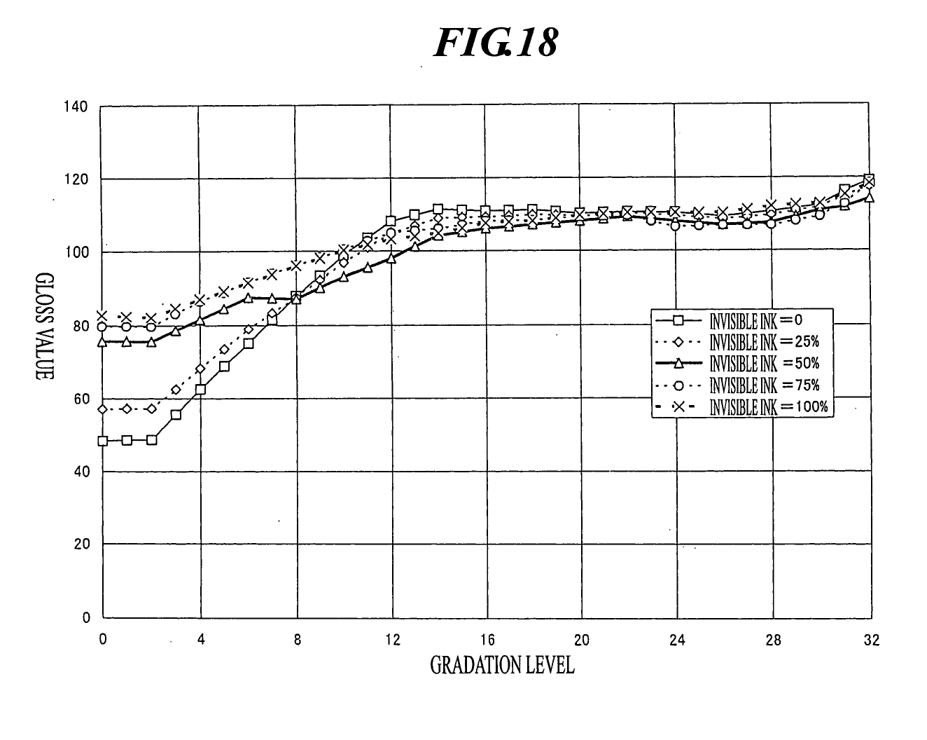

An image in which the sum total was set at 12.5% was created by forming at least one droplet of the recording ink or the colorless ink onto a unit of two blocks, that is, eight pixels, and a 60-degree specular gloss of an image-formed surface thereof was measured according to JIS-Z-8741. For the measurement, a variable angle gloss system (VGS-1001DP) made by Nippon Denshoku Industries Co., Ltd. was used. Gloss measurement values of the patches in which the sum totals were 25 to 100% are shown in FIG. 18.

In the sum total of 25%, though an improvement of the gloss was recognized, a lowering of the gloss on the highlighted portion was able to be recognized by visual evaluation in comparison with other portions. In the sum total of 12.5%, the unevenness of the gloss was apparent by the visual evaluation, and the image concerned was determined to be no good. From the above, it is understood that surface coverage of the recording medium by the dots is suitably 25% or more, which is 3 cc/m² or more in conversion to the amount of droplets. In the sum totals of 12.5% (1.5 cc/m²), the improvement effect is not sufficient.

Moreover, in the case of always setting the sum total of the adhered amounts of recording ink and colorless ink at 100% or more, it is not necessary to make the blocks for the calculation of the colorless ink, and the colorless ink can be always placed onto the pixels on which the recording ink is not present. According to this method, the calculation of the colorless ink is simplified, thus enabling to shorten a calculation time and simplification of the instrument.

### Example 2

In Example 2, the error diffusion method was used for both the halftone process and the calculation of the colorless ink amount. The recording inks for use were defined to be only dark colors which were four, and recoding conditions are as follows.

Recording resolution: Main scanning/sub-scanning 1080 dpi

Ink type: Cyan, magenta, black, yellow, and colorless ink (five in total)

Ink droplet: 6.7 pl

Main scanning speed: 705 mm/sec

Error diffusion resolution: 1080 dpi

Number of error diffusion levels: 2

The calculation of the colorless ink in this case was made based on the image data before the halftone process was performed for the recording ink. When the sum of CMYK data (8-bit value) is taken, a value thereof becomes the sum total of the recording inks. For example, when the data for the colorless ink is a (0 to 255), the sum total of the adhered amounts of colorless ink and recording ink is b, and the adhered amounts of the respective recording inks are Y, M, C and K, the sum total of the recording inks can be calculated by a formula of: a=255×(b/100)−(Y+M+C+K).

In the case of desiring to record the colorless ink at 50%, the data for the colorless ink is set at 128 at the maximum, and the usual halftone process is performed. Then, as a result, the colorless ink dots are formed on 50% of the recording medium. When the sum total of the adhered amounts of ink on the respective pixel positions is subtracted from 128, the colorless ink is reduced by the amount of recording ink, and as a result, the sum of the recording ink and colorless ink becomes 50% or more in the full recording region.

The sum total b of the adhered amounts of recording ink and colorless ink can be set arbitrarily. When the sum total b is larger than 255, the colorless ink will be placed onto the same pixel position twice or more. This can be easily realized even if the number of colorless ink nozzles is the same as the number of recording ink nozzles because, in the high-quality printing mode, it is common to perform overlap printing of making the recording while thinning the main scanning in order to improve usual image quality.

When such a configuration is adopted, the halftone process and the colorless ink calculation can be processed by the same algorithm, and accordingly, the need for preparing an algorithm separately from that for the colorless ink can be saved. In particular, in the case of packaging all the processes in the printer, cost of the apparatus can be reduced, and accordingly, this is effective.

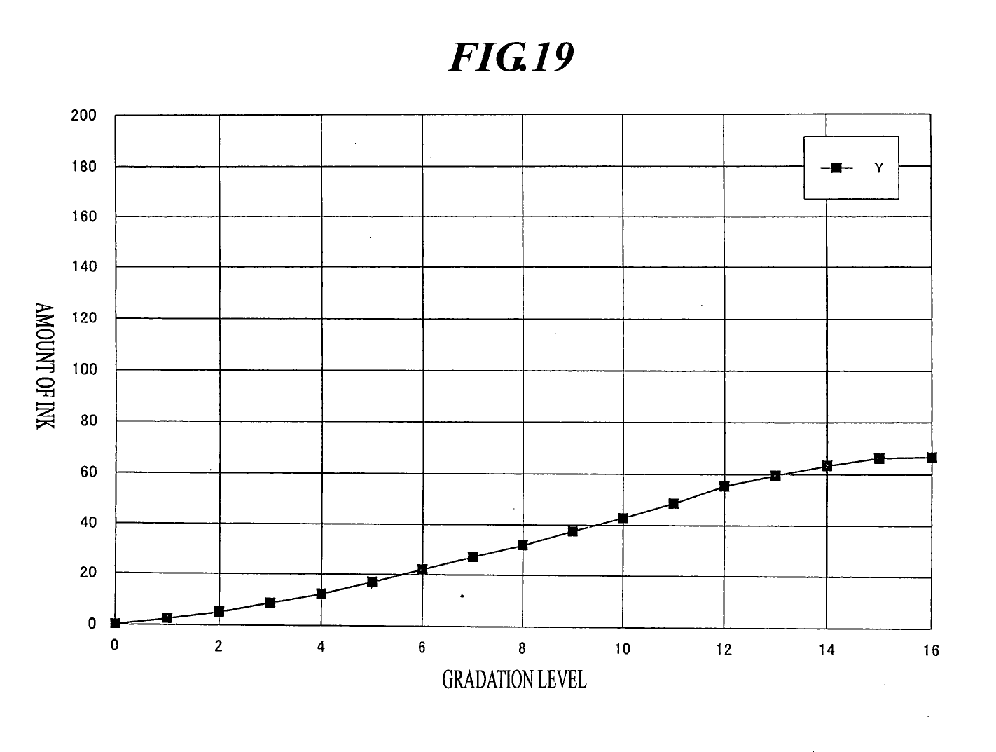

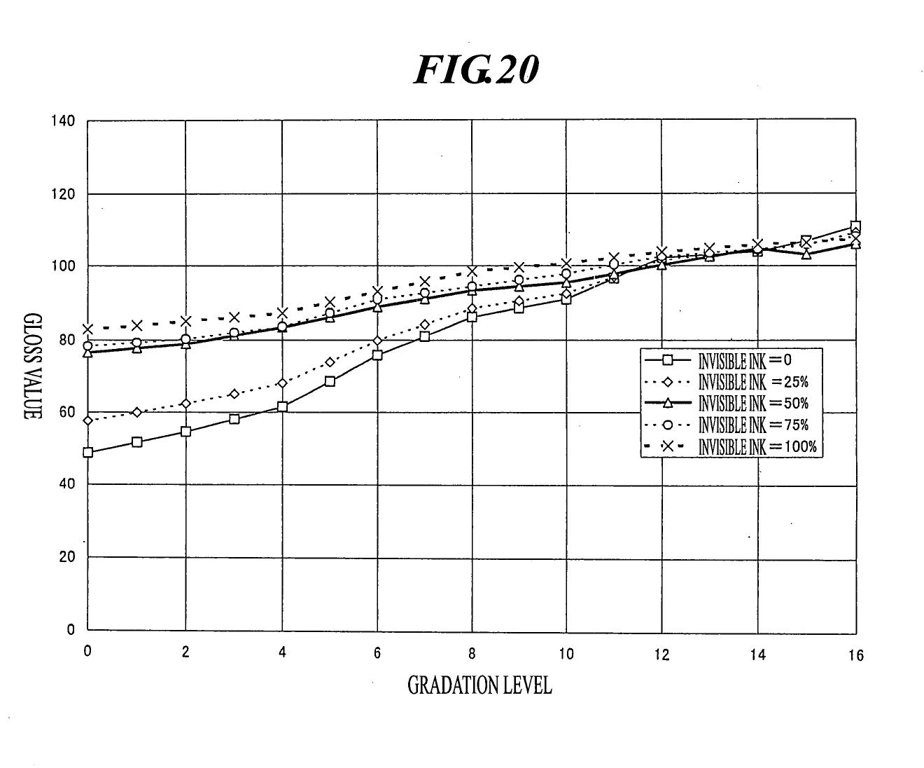

As the image data, 16 gradation patches (data value of 0, 16, 32 . . . , 240 and 255) of yellow were printed only by means of the Y ink. The maximum value of yellow was limited to 75% in advance. A size of each patch was set at 4 cm square so as to make it possible to measure the gloss values in a similar way to Example 1. FIG. 19 shows a graph in which the ink amount of the patch of each gradation level is plotted. Moreover, FIG. 20 shows a graph showing 60-degree gloss values when the colorless ink is changed from 25 to 100%. As shown in the graphs, an effect of improving the gloss, which is accompanied by an increase of the ink amount of colorless ink, is observed as in Example 1. Moreover, when the amount of colorless ink is 50% (6 cc/m²) or more as shown in FIG. 20, the effect of improving the gloss with respect to the adhered amount is small. Then, when the amount of colorless ink was set at 13 cc/m² or more, in such a pattern in which a blue or black thin line was present on a white base, a phenomenon that width of the line was blurred and widened by the colorless ink was observed. Specifically, from an economical viewpoint and an influence given to the image quality, there was a suitable value for the sum total of the adhered amounts in the unit area, and 2 cc/m² or more to less than 13 cc/m² was the optimum.

### Example 3

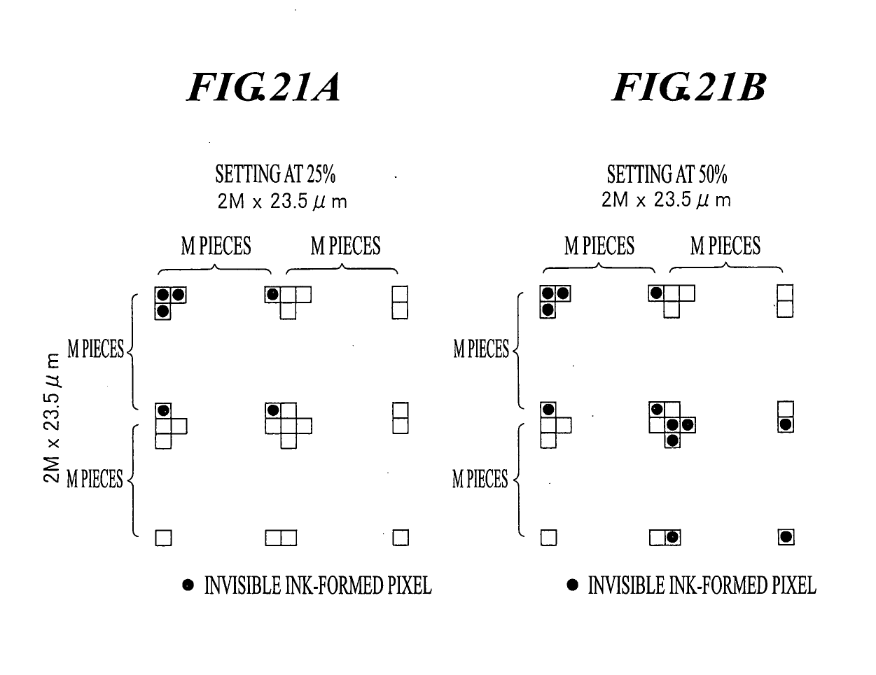

In Example 3, a suitable size of the calculation block of the colorless ink was studied. The sum total of the adhered amounts of colorless ink and recording ink was set at 25% and 50% or more, and visual evaluation was performed while changing the size of each block as shown in FIG. 21A and FIG. 21B. Here, 2M×2M pieces of pixels were used as the blocks, and in the setting at 25%, as shown in FIG. 21A, the colorless ink is formed on all the pixels of an upper left block thereof. In the setting at 50%, as shown in FIG. 21B, the colorless ink dots are formed on all the pixels of a lower left block thereof. Length of the block becomes 2M×23.5 μm assuming that one pixel is equivalent to 1080 dpi. Patches in which this length was changed from 0.09 mm (four-pixel block) to 4.7 mm (200-pixel block) were prepared. In this case, the recording ink was not placed on the medium at all, but only the colorless ink was placed thereon. Evaluation results are shown in Table 1.

TABLE 1

| | | | 25% | 50% |
|---|---|---|---|---|
| M | 2 M | Length(mm) | Evaluation | Evaluation |
| 2 | 4 | 0.09 | ◯ | ◯ |
| 4 | 8 | 0.19 | ◯ | ◯ |
| 10 | 20 | 0.47 | Δ | ◯ |
| 20 | 40 | 0.94 | Δ | Δ |
| 30 | 60 | 1.41 | X | Δ |
| 40 | 80 | 1.88 | X | X |
| 45 | 90 | 2.12 | X | X |
| 50 | 100 | 2.35 | X | X |
| 100 | 200 | 4.70 | X | X |

From the results, it was understood that the size of the block for controlling the colorless ink was suitably set at 1 mm or less. In the case of setting the size at 0.94 mm, though the unevenness of the gloss was slightly recognized, the texture like so-called matte gloss appears on the contrary. Accordingly, the above-described setting can be suitably used depending on preferences of a user.

1. An inkjet recording method comprising:
jetting recording ink containing a color material onto a recording medium by a recording head, and colorless ink for improving gloss onto the recording medium by the recording head, to perform image formation; and
determining an adhered amount of the colorless ink per unit area in response to an adhered amount of the recording ink per unit area.

2. The inkjet recording method of claim 1,
wherein a jetted position of the colorless ink is determined in response to a jetted position of the recording ink.

3. The inkjet recording method of claim 2,
wherein the jetted position of the colorless ink is determined preferentially from a position that is not adjacent to or overlapped on the jetted position of the recording ink.

4. The inkjet recording method of claim 1,
wherein the adhered amount of colorless ink is increased in a region where the adhered amount of recording ink is a predetermined amount or less than in a region where the adhered amount of recording ink is more than the predetermined amount.

5. The inkjet recording method of claim 1,
wherein the unit area for the adhered amounts of the colorless ink and the recording ink is set at 1 mm square or less, and a sum total of the adhered amounts of the colorless ink and the recording ink in the unit area is set at a predetermined amount or more.

6. The inkjet recording method of claim 5,
wherein the sum total of the adhered amounts of the colorless ink and the recording ink in the unit area is 2 cc/m² or more.

7. The inkjet recording method of claim 6,
wherein the sum total of the adhered amounts of the colorless ink and the recording ink in the unit area is less than 13 cc/m².

8. The inkjet recording method of claim 5,
wherein the unit area for the adhered amounts of the colorless ink and the recording ink is set as a block formed of an aggregate of n (n>1) pieces of pixels.

9. The inkjet recording method of claim 8,
wherein a jetted position of the colorless ink jetted onto the block is determined preferentially from a pixel in which the adhered amount of the recording ink is smaller.

10. The inkjet recording method of claim 1,
wherein the unit area for the adhered amounts of the colorless ink and the recording ink is defined as one pixel, and a sum total of the adhered amounts of the colorless ink and the recording ink in the unit area is set at a predetermined amount or more.

11. The inkjet recording method of claim 1,
wherein the recording ink contains fine particles.

12. The inkjet recording method of claim 1,
wherein the recording medium includes a micro-porous recording medium.

13. The inkjet recording method of claim 1,
wherein a surface layer of the recording medium contains a thermoplastic resin.

14. The inkjet recording method of claim 13,
wherein a fixing process including heating or pressurization is implemented for the recording medium on which the recording ink and the colorless ink are jetted.

15. The inkjet recording method of claim 1,
wherein a rate of light absorbance change in mixing the recording ink and the colorless ink with each other is less than 5%.

16. An inkjet recording method comprising:
jetting recording ink containing a color material onto a recording medium by a recording head, and a colorless ink for improving gloss onto the recording medium by the recording head, to perform image formation,
wherein a rate of light absorbance change in mixing the recording ink and the colorless ink with each other is less than 5%.

17. An inkjet printer, comprising:
an image forming unit to jet recording ink containing a color material onto a recording medium by a recording head, and jet colorless ink for improving gloss onto the recording medium by the recording head, thereby performing image formation; and
a control unit to control the image forming unit,
wherein the control unit determines an adhered amount of the colorless ink per unit area in response to an adhered amount of the recording ink per unit area.

18. The inkjet printer of claim 17,
wherein the control unit determines a jetted position of the colorless ink in response to a jetted position of the recording ink.

19. The inkjet printer of claim 18,
wherein the control unit determines the jetted position of the colorless ink preferentially from a position that is not adjacent to or overlapped on the jetted position of the recording ink.

20. The inkjet printer of claim 17,
wherein the control unit increases the adhered amount of the colorless ink in a region where the adhered amount of the recording ink is a predetermined amount or less than in a region where the adhered amount of the recording ink is more than the predetermined amount.

21. The inkjet printer of claim 17,
wherein the control unit sets the unit area for the adhered amounts of the colorless ink and the recording ink at 1 mm square or less, and sets a sum total of the adhered amounts of the colorless ink and the recording ink in the unit area at a predetermined amount or more.

22. The inkjet printer of claim 21,
wherein the control unit sets the sum total of the adhered amounts of the colorless ink and the recording ink in the unit area at 2 cc/m² or more.

23. The inkjet printer of claim 22,
wherein the control unit sets the sum total of the adhered amounts of the colorless ink and the recording ink in the unit area at less than 13 cc/m².

24. The inkjet printer of claim 21,
wherein the control unit sets the unit area for the adhered amounts of the colorless ink and the recording ink as a block formed of an aggregate of n (n>1) pieces of pixels.

25. The inkjet printer of claim 24,
wherein the control unit determines a jetted position of the colorless ink jetted onto the block preferentially from a pixel in which the adhered amount of the recording ink is smaller.

26. The inkjet printer of claim 17,
wherein the control unit defines the unit area for the adhered amounts of the colorless ink and the recording ink as one pixel, and sets a sum total of the adhered amounts of the colorless ink and the recording ink in the unit area at a predetermined amount or more.

27. The inkjet printer of claim 17,
wherein the recording ink contains fine particles.

28. The inkjet printer of claim 17,
wherein the recording medium includes a micro-porous recording medium.

29. The inkjet printer of claim 17,
wherein a surface layer of the recording medium contains thermoplastic resin.

30. The inkjet printer of claim 29,
wherein a fixing process including heating or pressurization is implemented for the recording medium on which the recording ink and the colorless ink are jetted.

31. The inkjet printer of claim 17,
wherein a rate of light absorbance change in mixing the recording ink and the colorless ink with each other is less than 5%.

32. An inkjet printer, comprising:
an image forming unit to jet recording ink containing a color material onto a recording medium by a recording head, and jet colorless ink for improving gloss onto the recording medium by the recording head, thereby performing image formation; and
a control unit to control the image forming unit,
wherein a rate of light absorbance change in mixing the recording ink and the colorless ink with each other is less than 5%.
